(19) United States
(12) Patent Application Publication
(10) Pub. No.: US 2021/0270864 A1
(43) Pub. Date: Sep. 2, 2021

(54) AUTOSAMPLERS AND ANALYTIC SYSTEMS AND METHODS INCLUDING SAME

(71) Applicant: PerkinElmer Health Sciences, Inc., Waltham, MA (US)

(72) Inventors: Anthony Chiappetta, Milford, CT (US); Keith Ferrara, Stratford, CT (US); Eugene P. Gerety, Seymour, CT (US); Szilveszter C. Jando, Naugatuck, CT (US); Samuel Tolley, Hamden, CT (US)

(21) Appl. No.: 17/060,752

(22) Filed: Oct. 1, 2020

Related U.S. Application Data
(60) Provisional application No. 62/984,039, filed on Mar. 2, 2020.

(51) Int. Cl. G01N 35/10; G01N 35/00

(52) U.S. Cl. CPC G01N 35/1009; G01N 35/00584

(57) ABSTRACT

An autosampler includes a sample carrier for receiving first and second sets of sample containers each having a top end, a side wall, and a visible indicium on its side wall. The autosampler includes: an optical sensor to read the visible indicia and to generate a corresponding output signal; a controller to receive the output signal; and a sampling system to withdraw a sample. The sample carrier supports the first and second sets of sample containers at different heights such that the indicia of the sample containers of the second set are located above the top ends of the sample containers of the first set, whereby the indicia of the sample containers of the second set are exposed to the optical sensor over the top ends of the sample containers of the first set, thereby enabling the optical sensor to read the indicia of the second set of sample containers.

### RELATED APPLICATION(S)

The present application claims the benefit of and priority from U.S. Provisional Patent Application No. 62/984,039, filed Mar. 2, 2020, the disclosure of which is incorporated herein by reference in its entirety.

### FIELD

The present technology relates to autosamplers and, more particularly, to autosamplers including optical sensors and/or RFID tags.

### BACKGROUND

Autosamplers are often used to selectively supply sample components to an analytical device such as a gas chromatograph. An autosampler may include a platter or other sample carrier and vials or other containers that are held in the sample carrier. Solid, liquid or gaseous samples are provided in the vials. The autosampler may deliver each vial to a prescribed position in the autosampler or the analytical device, for example, where an aliquot of the sample is removed from the vial. Alternatively, the autosampler may move a sampling device (e.g., an aspirating probe) to each vial to remove a sample from the vial.

Traceability of samples is extremely important in analytical laboratories. Some approaches to solve this problem include adding barcodes to sample containers that give each sample container a unique identification. The unique identification is logged into a database for tracking.

The sample containers or vials may be held in a sample tray or carrier, which is then loaded or mounted on the autosampler. Each sample carrier may have a different configuration, including the number and arrangement of the sample vials. The configuration and presence of a sample carrier is typically manually entered into a user interface of the autosampler.

### SUMMARY

According to some embodiments, an autosampler includes a sample carrier for receiving a first set of sample containers and a second set of sample containers, each of the sample containers having a top end, a side wall, and a visible indicium on its side wall. The autosampler further includes: an optical sensor configured to read the visible indicia and to generate an output signal corresponding thereto; a controller configured to receive the output signal; and a sampling system to withdraw a sample from at least one of the sample containers. The sample carrier supports the first and second sets of sample containers at different heights such that the indicia of the sample containers of the second set are located above the top ends of the sample containers of the first set, whereby the indicia of the sample containers of the second set are exposed to the optical sensor over the top ends of the sample containers of the first set, thereby enabling the optical sensor to read the indicia of the second set of sample containers.

In some embodiments, the sample carrier includes tiered first and second support features to receive the first set of sample containers and the second set of sample containers, respectively.

According to some embodiments, the first and second support features include seats each configured to hold and positively position an individual sample container in the sample carrier.

According to some embodiments, the seats of the first support feature are arranged in a first row, and the seats of the second support feature are arranged in a second row located behind the first row.

In some embodiments, the first and second rows are arcuate, and the autosampler is configured to rotate the sample carrier and/or the optical sensor relative to one another.

The autosampler may include a vacancy marker on the sample carrier. When the vacancy marker is exposed to the optical sensor, the autosampler determines that no sample container is mounted in a corresponding location in the sample carrier.

In some embodiments, the vacancy marker is disposed on an upstanding wall of the sample carrier located behind the corresponding location in the sample carrier such that: when no sample container is mounted in a corresponding location in the sample carrier, the vacancy marker is exposed to the optical sensor; and when a sample container is mounted in the corresponding location, the vacancy marker is obfuscated from the optical sensor by said sample container.

According to some embodiments, the optical sensor has a field of view, and the indicium of a sample container of the first set and the indicium of a sample container of the second set located behind said sample container of the first set are simultaneously disposed in the field of view of the optical sensor.

In some embodiments, the autosampler includes at least one mirror configured to simultaneously reflect an image of the indicium of the sample container of the first set and an image of the indicium of the sample container of the second set to the optical sensor.

The autosampler may include a mirror configured to reflect an image of indicia from a sample container of the second set to the optical sensor.

The autosampler may include a folding mirror optically interposed between the optical sensor and the at least one mirror.

In some embodiments, the optical sensor has a central line of sight that is oriented at an oblique angle to a heightwise axis of the sample carrier.

According to some embodiments, the sampling system includes a sampling station, and the optical sensor is mounted on the sampling station and configured to read the indicium of each sample container when the sample container is positioned adjacent the sampling station.

In some embodiments, the sampling station includes a sampling head. The sampling head includes a probe. The autosampler includes at least one actuator operable to selectively move the sampling head relative to the sample carrier. The autosampler includes a passive gripper mounted on the sampling head for movement with the sampling head. The passive gripper is configured to releasably grasp and hold the sample containers to remove the sample containers from the sample carrier.

According to some embodiments, an autosampler includes a sample carrier for receiving a first sample container and a second sample container, each of the first and second sample containers having a top end, a side wall, and a visible indicium on its side wall. The autosampler further includes: an optical sensor configured to read the visible indicia and to generate an output signal corresponding thereto; a controller configured to receive the output signal; and a sampling system to withdraw a sample from at least one of the sample containers. The sample carrier is configured to support the first and second sample containers such that the indicia of the second sample container is located at a height greater than a height of the top end of the first sample container, whereby the indicia of the second sample container is exposed to the optical sensor over the top end of the first sample container, thereby enabling the optical sensor to read the indicia of the second sample container.

According to some embodiments of the invention, an autosampler includes a platform that defines one or more sample carrier positions; at least one sample carrier that is mounted on the platform in one of the sample carrier positions, the at least one sample carrier having an RFID tag thereon and being configured to receive a plurality of sample containers; at least one RFID reader mounted on the autosampler and configured to receive a signal from the RFID tag on the sample carrier; and a sampling system to enable the withdrawal of a sample from at least one of the sample containers.

In some embodiments, the at least one RFID reader is positioned at one of the one or more sample carrier positions to receive a signal from the RFID tag on the at least one sample carrier when the at least one sample carrier is mounted on the platform at the one of the one or more sample carrier positions.

In some embodiments, the at least one sample carrier position comprises a plurality of sample carrier positions, wherein the at least one RFID reader comprises a plurality of RFID readers, each of the plurality of RFID readers being positioned at corresponding ones of the plurality of sample carrier positions and configured to receive a signal from one of the at least one sample carrier that is positioned in one of the plurality of sample carrier positions.

In some embodiments, the sampling system further comprises a sample probe to collect a sample from one of the plurality of sample containers and a positioning system configured to move the sample probe.

In some embodiments, the platform is configured to move the one or more sample carriers, and the at least one RFID reader is positioned on a stationary component of the autosampler that is stationary with respect to the platform.

In some embodiments, the one or more sample carriers are wedge-shaped.

In some embodiments, the signal from the RFID tag on the sample carrier comprises information defining a location and/or presence of the sample carrier on the platform.

In some embodiments, the signal from the RFID tag comprises a configuration of the sample carrier including a number and arrangement of sample containers and/or size of the sample carrier.

In some embodiments, the RFID tag comprises a temperature sensor, and the RFID reader is configured to provide power to the temperature sensor and to receive a signal comprising a temperature reading from the RFID tag temperature sensor.

In some embodiments, the autosampler comprises a sampling system RFID tag mounted on the sampling system, the sampling system RFID tag comprising a temperature sensor to detect a temperature of the sampling system.

In some embodiments, the sampling system comprises a syringe and the sampling system RFID tag is mounted on the syringe.

In some embodiments, the auto sampler comprises a sampling system RFID reader that is configured to receive temperature data from the sampling system RFID tag.

According to some embodiments of the invention, a method for sampling is provided. The method includes providing an autosampler including a platform, wherein the platform defines one or more sample carrier positions; mounting at least one sample carrier on the platform in one of the sample carrier positions, the at least one sample carrier being configured to receive a plurality of sample containers and having an RFID tag thereon; receiving a signal from the RFID tag on the sample carrier using at least one RFID reader mounted on the autosampler; determining a configuration and/or position of the sample carrier responsive to the signal from the RFID tag; and withdrawing a sample from at least one of the sample containers with a sample system based on the configuration and/or position of the sample carrier.

According to some embodiments of the disclosure, an autosampler includes a platform that defines one or more sample carrier positions; at least one sample carrier that is mounted on the platform in one of the sample carrier positions, the at least one sample carrier having at least one magnet thereon and being configured to receive a plurality of sample containers; a sampling system to enable the withdrawal of a sample from at least one of the sample containers; and at least one magnetic field detector mounted on the autosampler and configured to detect a magnetic field from the at least one magnet on the sample carrier to thereby identify a position of the at least one sample carrier mounted on the platform. In an example embodiment, the one or more sample carriers may be wedge-shaped, and may include two, three, four, five, six or more wedges. The at least one sample carrier may comprise a plurality of sample carriers, with each of the plurality of sample carriers corresponding to one of a plurality of magnetic field patterns that identify a configuration of the sample carrier.

In some embodiments, each of the plurality of magnetic field patterns comprises and/or is generated by a pattern of filled and/or unfilled magnet positions. Such a pattern may be, for example, a pre-determined pattern that may be uniquely associated with a sample carrier. The at least one magnetic field detector mounted on the autosampler may, for example, comprise a Hall effect or other sensor that is configured to detect a presence or absence of one or more magnets in the pattern of filled and/or unfilled magnet positions. Accordingly, in some embodiments, each of the plurality of magnetic field patterns may correspond to and identify a configuration of the sample carrier, where such configuration may further include a number and arrangement of sample containers and/or a size of the sample carrier.

In some embodiments, the platform is rotatable, and the auto sampler further comprises an indicia mounted on the platform that identifies a reference position of the platform. An indicia detector may be configured to detect a reference position of the indicia when the platform is rotated.

In some embodiments, a Hall effect sensor is configured to generate a signal when the platform is rotated, the signal indicating when a presence or absence of a magnet in the pattern of filled and/or unfilled magnet positions is proximate the Hall effect sensor. A signal analyzer that receives the signal from the Hall effect sensor and the indicia detector may generate, determine, and/or allow for the determination of a position and identity of the at least one sample carrier that is mounted on the platform, such determination in response to (i) the reference position of the platform as identified by the position of the indicia, and (ii) the one or more signals corresponding to the one or more magnets, indicating when a presence or absence of the one or more magnets in the pattern of filled and/or unfilled magnet positions is proximate the Hall effect sensor.

In some embodiments, the sampling system further comprises a sample probe to collect a sample from one of the plurality of sample containers and a positioning system configured to move the sample probe.

The platform may be configured to move the one or more sample carriers, and the at least one magnetic field detector is positioned on a stationary component of the autosampler that is stationary with respect to the platform.

According to some embodiments of the present disclosure, methods for sampling include providing an autosampler including a platform, wherein the platform defines one or more sample carrier positions; mounting at least one sample carrier on the platform in one of the sample carrier positions, the at least one sample carrier being configured to receive a plurality of sample containers and having at least one magnet thereon; receiving a signal corresponding to a magnetic field on the sample carrier using a magnetic field detector mounted on the autosampler; determining a configuration and/or a position of the sample carrier responsive to the signal from the magnetic field detector; and withdrawing a sample from at least one of the sample containers with a sample system based on the configuration and/or position of the sample carrier.

### BRIEF DESCRIPTION OF THE DRAWINGS

FIG. 1 is an example of one sample analyzer system according to the present disclosure.

FIG. 2 is a perspective view of a sample container forming a part of the sample analyzer system of FIG. 1.

FIG. 3 is a fragmentary, perspective view of an autosampler forming a part of the sample analyzer system of FIG. 1.

FIG. 4 is a fragmentary, side view of the autosampler of FIG. 3.

FIG. 5 is a top view of the autosampler of FIG. 3.

FIG. 6 is an enlarged, fragmentary, top view of the autosampler of FIG. 3.

FIG. 7 is a fragmentary, cross-sectional view of the autosampler of FIG. 3.

FIG. 8 is a fragmentary, cross-sectional view of the autosampler of FIG. 3.

FIG. 9 represents an image acquired by an optical reader forming a part of the sample analyzer system of FIG. 1.

FIG. 10 is a fragmentary, perspective view of the autosampler of FIG. 3.

FIG. 11 is a schematic diagram representing a controller forming a part of the sample analyzer system of FIG. 1.

FIG. 12 is a top perspective view of a sample analyzer system according to further embodiments.

FIG. 13 is a side view of the sample analyzer system of FIG. 12.

FIG. 14 is a fragmentary, perspective view of an autosampler forming a part of the sample analyzer system of FIG. 12.

FIG. 15 is a fragmentary, side view of an autosampler according to further embodiments.

FIG. 16 is a top perspective view of a sample analyzer system according to further embodiments.

FIG. 17 is a top perspective view of a platform and a sample carrier configuration of the sample analyzer system of FIG. 16.

FIG. 18 is a top perspective view of a sample carrier of the sample analyzer system of FIG. 16.

FIG. 19 is a bottom perspective view of the sample carrier of FIG. 18.

FIG. 20 is a top perspective view of an arm for holding the platform of FIG. 17.

FIG. 21 is a fragmentary, side perspective view of the sample carrier and platform of FIG. 17.

FIG. 22 is a perspective view of a syringe configuration for use with the sample analyzer system of FIG. 16.

FIG. 23 is a schematic diagram representing the sample analyzer system of FIG. 16.

FIG. 24 is a schematic diagram representing a controller forming a part of the sample analyzer system of FIG. 16.

FIG. 25 is a fragmentary perspective view of the sample analyzer system of FIG. 16.

FIG. 26 is a perspective view of a gripper forming a part of the sample analyzer system of FIG. 16.

FIG. 27 is a top view of the gripper of FIG. 26.

FIG. 28 is a side view of the gripper of FIG. 26.

FIGS. 29-31 are fragmentary side views of the sample analyzer system of FIG. 16 illustrating a procedure using the gripper to transport a sample container.

FIG. 32 is an enlarged, fragmentary, cross-sectional view of the sample analyzer system of FIG. 16 taken along the line 32-32 of FIG. 30.

FIG. 33 is a top perspective view of a platform and a sample carrier configuration according to some embodiments.

FIG. 34 is a bottom perspective view of a sample carrier of FIG. 33.

FIG. 35 is a fragmentary, side perspective view of the sample carrier and platform of FIG. 33.

FIG. 36 is another fragmentary, side perspective view of the sample carrier and platform of FIG. 33.

FIG. 37 is a bottom view of the underside of the sample carriers as positioned on the platform of FIG. 33.

FIG. 38 is a schematic diagram representing a sample analyzer system according to some embodiments.

FIG. 39 is a schematic diagram representing a controller forming a part of the sample analyzer system of FIG. 38.

FIG. 40 is an example of a graph of signals detected by the magnetic field detector of the platform and sample carrier configuration of FIG. 33.

### DETAILED DESCRIPTION

The present technology now will be described more fully hereinafter with reference to the accompanying drawings, in which illustrative embodiments of the technology are shown. In the drawings, the relative sizes of regions or features may be exaggerated for clarity. This technology may, however, be embodied in many different forms and should not be construed as limited to the embodiments set forth herein; rather, these embodiments are provided so that this disclosure will be thorough and complete, and will fully convey the scope of the technology to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed herein could be termed a second element, component, region, layer or section without departing from the teachings of the present technology.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

As used herein, “monolithic” means an object that is a single, unitary piece formed or composed of a material without joints or seams. Alternatively, a unitary object can be a composition composed of multiple parts or components secured together at joints or seams.

The term “automatically” means that the operation is substantially, and may be entirely, carried out without human or manual input, and can be programmatically directed or carried out.

The term “programmatically” refers to operations directed and/or primarily carried out electronically by computer program modules, code and/or instructions.

The term “electronically” includes both wireless and wired connections between components.

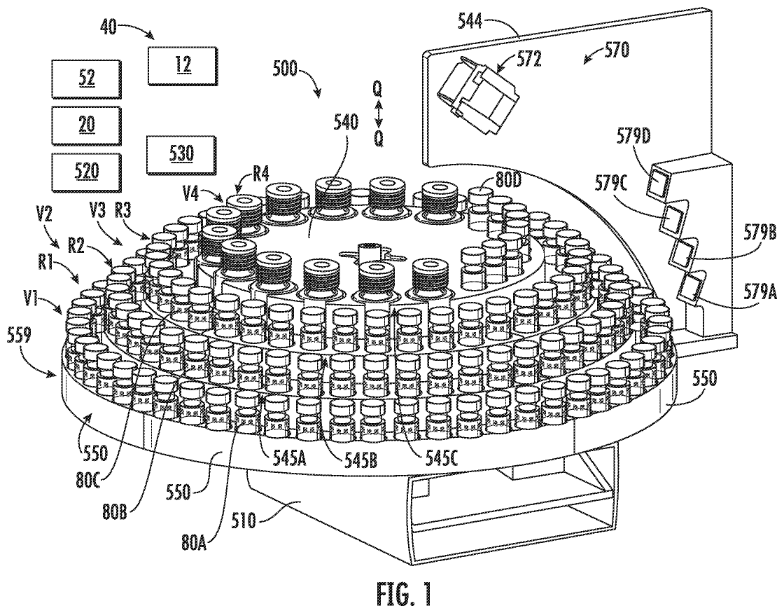

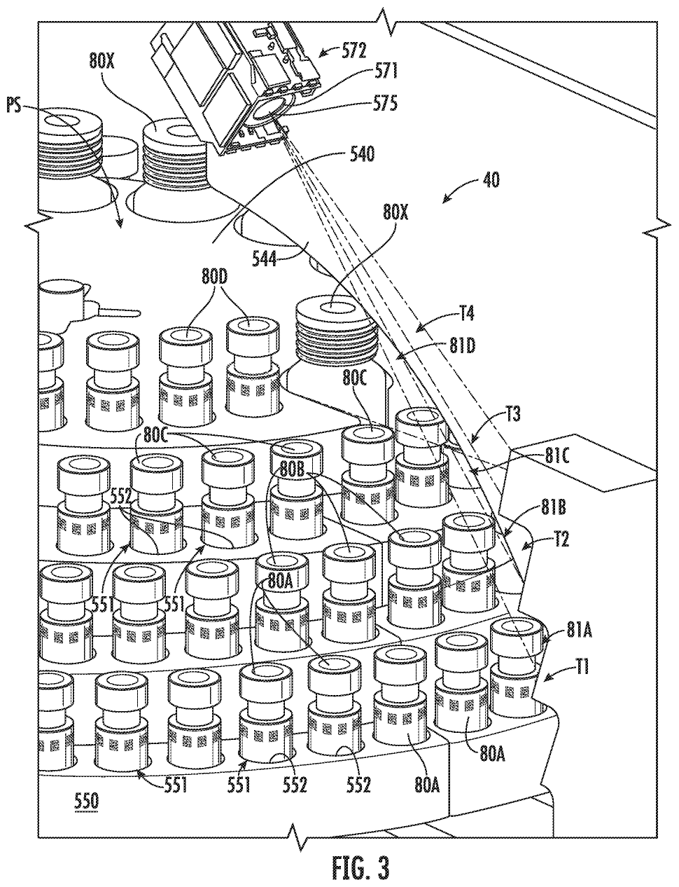

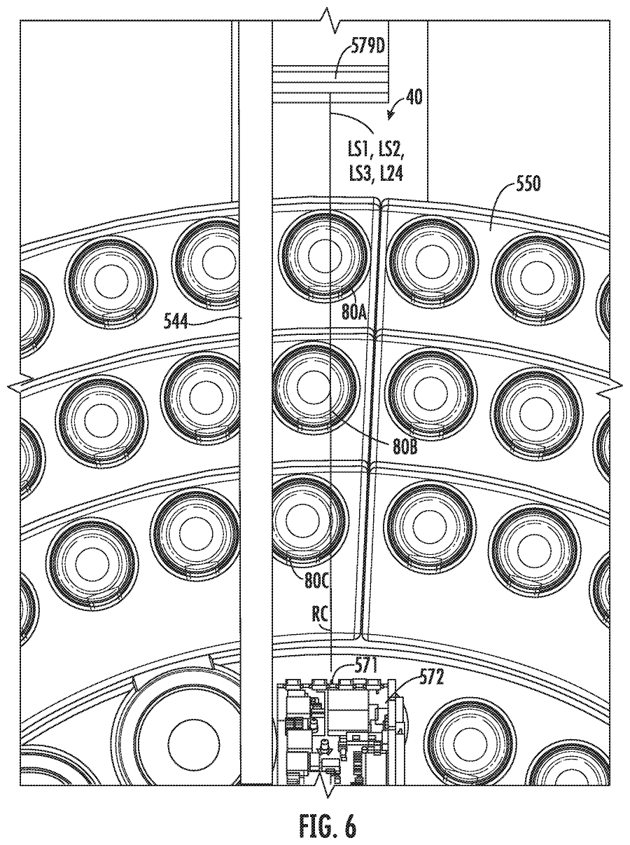

With reference to FIGS. 1-11, a sample analyzer system 40 according to further embodiments of the technology is shown therein (schematically, in part). The sample analyzer system 40 includes an automated sampler device or autosampler 500, an analytical instrument 20, a controller 52, and a plurality of sample containers 80 (FIG. 3). The system 40 may include a human-machine interface (HMI) 12 such as a display with a touchscreen. According to embodiments of the technology, the autosampler 500 is configured and used to supply samples from the sample containers 80 to the analytical instrument 20. For example, in some embodiments, the autosampler 500 automatically and programmatically supplies samples from the sample containers 80 to the analytical instrument 20, and the analytical instrument 20 serially processes the supplied samples.

The analytical instrument 20 may be any suitable apparatus for processing a sample or samples. The analytical instrument 20 may include one or more systems for analyzing a sample in a container such as a tube, including but not limited to an atomic absorber, an inductively coupled plasma (ICP) instrument, a gas chromatography system, a liquid chromatography system, a mass spectrometer, a thermal measurement instrument such as a calorimeter or thermogravimetric analyzer, a food (e.g., grain, dough, flour, meat, milk, etc.) analyzer, or combinations of any of the foregoing, for example.

With reference to FIG. 1, the illustrated autosampler 500 includes a platform 510, an extraction or sampling system 520, a positioning system 530, a sample container monitoring system 570 (including an optical reader 572), a hub 540, and one or more sample carriers 550. The hub 540 and the sample carriers 550 together form a sample carrier assembly 559. In some embodiments, the hub 540 also serves as a sample carrier.

The illustrated sample carrier assembly 559 is configured and mounted as to operate as a carousel. In use, the sample carrier assembly 559 is mounted on the platform 510 such that the sample carrier assembly 559 can be rotated about a central rotation axis Q. In some embodiments, the sample carrier assembly 559 may be a discrete component that is conveniently removable from the platform 510. In some embodiments, the sample carriers 550 are individual sample carrier units that can be selectively removed from the hub 540. In some embodiments, a unitary sample carrier including an integral hub is provided in place of the sample carrier assembly 559.

The sampling system 520 is schematically illustrated and may be any suitable apparatus as described herein with regard to the system 10, for example. The sampling system 520 may be configured to extract or withdraw samples from the sample containers 80 in any suitable manner. For example, the sampling system 520 may include a sampling head including a probe (e.g., a syringe and needle probe). The sampling system 520 may include a robotic end effector and other mechanism that selectively removes the sample containers 80 from the sample carrier and relocates or deposits the sample containers 80 in a new location (in the sample carrier 550 or elsewhere) for further processing.

The positioning system 530 includes an actuator operable to selectively rotate the hub 540 (and thereby the sample carrier assembly 559 and the sample carriers 550) about the axis Q, to thereby selectively position the sample containers 80 with respect to an optical reader, such as a barcode reader 572.

The controller 52 may be any suitable device or devices for providing the functionality described herein. The controller 52 may include a plurality of discrete controllers that cooperate and/or independently execute the functions described herein. The controller 52 may include a microprocessor-based computer.

The sample container monitoring system 570 includes an optical sensor 571 (FIG. 3) and a plurality (as shown, four) mirrors 579A-D that may be mounted on a support, such as an arm 544.

According to some embodiments, the optical sensor 571 forms a part of an optical reader 572. In some embodiments, the optical reader is a barcode reader 572. The barcode reader 572 has an optical reception window 575 (FIG. 3). The illustrated barcode reader 572 may include a lens in or adjacent the reception window 575 that provides the optical sensor 571 with an extended or wide angle field of view. The sample container monitoring system 570 may include a supplemental light source apart from or integrated into the barcode reader 572.

Suitable barcode readers for the optical sensor 571 and barcode reader 572 may include a camera or laser scanner barcode reader, for example.

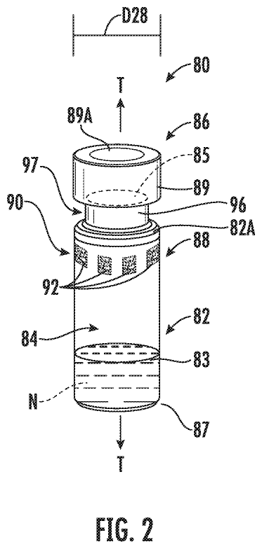

An exemplary one of the sample containers 80 is shown in FIG. 2. The sample container 80 has a top end 86 and an opposed bottom end 87. The sample container 80 has a container axis T-T extending between the top end 86 and the bottom end 87.

The sample container 80 includes a vessel 82. In some embodiments, the vessel 82 is a cylindrical vial as shown. The vessel 82 includes a sidewall 83 and defines a containment chamber 84 terminating at an inlet opening 85 at or proximate the top end 86. The vessel 82 may be formed of any suitable material(s) (e.g., polymer, metal or glass).

The sample container 80 may further include an inlet end cap 89 fluidly sealing the opening and having a penetrable septum 89A. The septum 89A may be formed of any suitable material(s). In some embodiments, the septum 89A is formed of a rubber.

The sample container 80 has an indicia region 88 on the sidewall 83. The sample container 80 further includes visible indicium 90 on the sidewall 83 in the indicia region 88.

The visible indicium 90 may be any suitable computer readable indicium. The visible indicium 90 may be any suitable coded, symbolic or identifying indicium. In some embodiments, the visible indicium 90 is a two-dimensional barcode. In some embodiments and as shown in the figures, the visible indicium 90 is a two-dimensional data matrix barcode distributed across the height and circumference of the sample container 80. The indicium 90 may include one or more forms of indicia.

In some embodiments and as shown in the figures, the visible indicium 90 includes an indicium pattern 92 that is repeated about the circumference of the sample container 80 so that substantially the entire indicium pattern or a sufficient portion thereof will be visible from every side of the sample container 80.

The barcode (or other visible indicium) 90 may be formed of any suitable material(s) and may be secured to the vessel 82 by any suitable technique. In some embodiments, the barcode 90 is permanently located (i.e., secured or formed) on the vessel 82. In some embodiments, the barcode 90 is permanently embossed or etched into a surface (e.g., the outer surface) of the vessel 82. In some embodiments, the barcode 90 is printed (and, in some embodiments, permanently printed) on a surface (e.g., the outer surface) of the vessel 82. In some embodiments, the barcode 90 is located (e.g., printed) on a separate label component (e.g., a self-adhesive backed label) that is adhered onto a surface (e.g., the outer surface) of the vessel 82. The foregoing are meant as exemplary and not intended as limitations on the characteristics of the visible indicium.

The sample carrier assembly 559 may be configured to be stably mounted on the platform 510, for example. For example, in some embodiments and as shown, the hub 540 is rotatably mounted on the platform 510, and the sample carriers 550 are mounted on and supported by the hub 540 to rotate with the hub 540.

Each sample carrier 550 may be a platter, tray, rack or any like structure that is capable of seating one or more sample containers 80. In some embodiments, a plurality of sample container seats 551 (FIG. 3) are provided in the sample carrier 550. In some embodiments, a plurality of seats 551 are also provided in the hub 540. Each seat 551 includes one or more openings defining a bore, receptacle, well or slot 552 sized to receive (from above), positively position, and releasably hold a respective sample container 80 or other type of container (e.g., a sample container 80X containing wash or rinse fluid).

The seats 551 may be arranged in a prescribed configuration so that each seat has a prescribed location in the sample carrier 550 or hub 540, and thereby a prescribed location in the sample carrier assembly 559. A sample container or other container mounted in the seat has a corresponding prescribed location in the sample carrier 550 or hub 540 and in the sample carrier assembly 559.

In some embodiments, the seats 551 are arranged in an array. In some embodiments and as shown, the seats 551 are arranged in a circular array. In other embodiments, the seats 551 may be arranged in an arcuate or a two-dimensional array having substantially linear or rectilinear rows of seats.

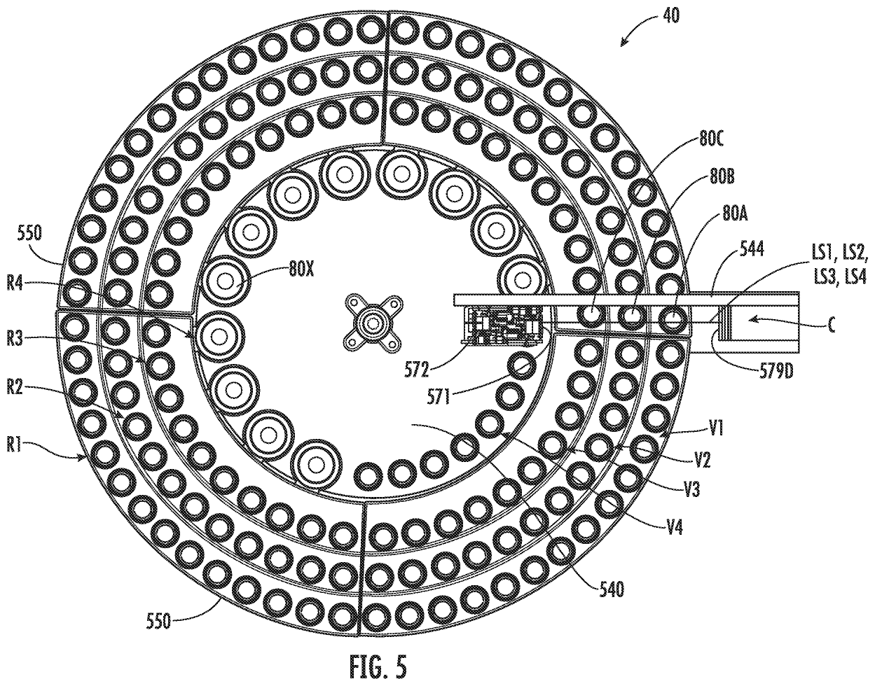

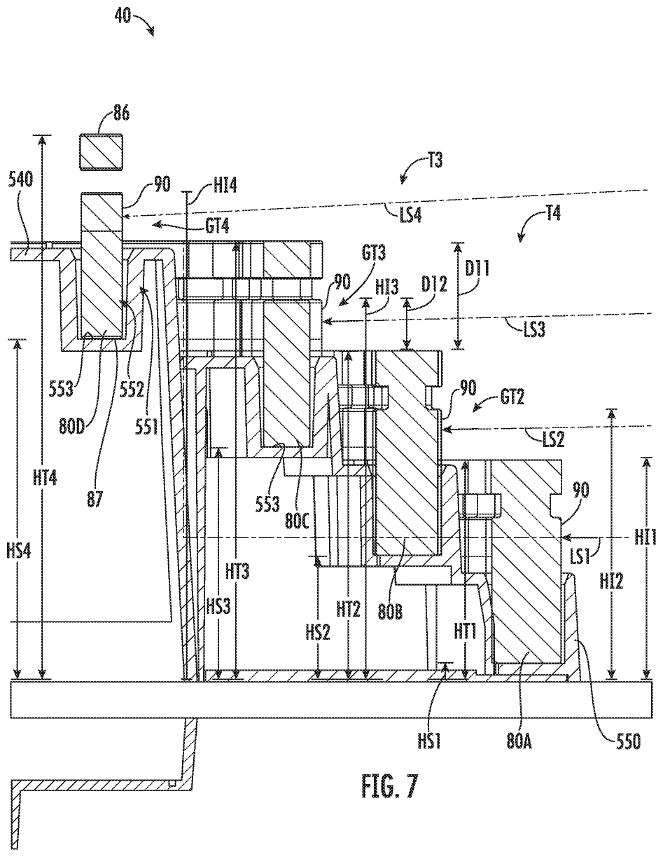

In some embodiments and as shown in FIGS. 5 and 7, the seats 551 are arranged in the sample carriers 550 and the sample carrier assembly 559 in an array including a plurality of sequential, side-by-side or nested, elliptical rows R1, R2, R3 and R4. In some embodiments, the rows R1-R4 extend around a central rotation axis Q (FIG. 1). In some embodiments and as shown, the rows R1-R4 are substantially concentric about the central rotation axis Q. In some embodiments, the rows R1-R4 are substantially circular or truncated circular. Although the illustrated embodiments comprise four rows, the present disclosure is not so limited and two or more rows may be used based on the embodiment.

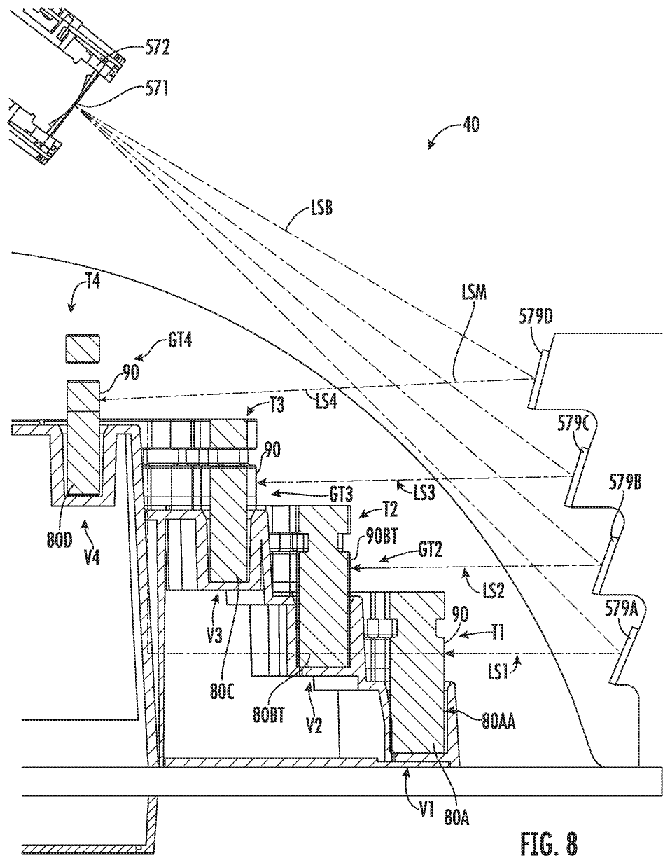

With reference to FIG. 8, the illustrated sample carrier assembly 559 is tiered and includes a first level or tier T1, a second level or tier T2 disposed at a height above the first level T1, a third level or tier T3 disposed at a height above the second level T2, and a fourth level or tier T4 disposed at a height above the third level T3. In the illustrated embodiment, the second tier T2 is radially inset from the first tier T1, the third tier T3 is radially inset from the second tier T2, and the fourth tier T4 is radially inset from the third tier T3. The illustrated sample carrier assembly 559 defines a first step 545A from the first tier T1 to the second tier T2, a second step 545B from the second tier T2 to the third tier T3, and a third step 545C from the third tier T3 to the fourth tier T4. For the illustrated embodiments, there is a tier T1-T4 for each row R1-R4 of sample container seats, although it can be understood that such a 1:1 correspondence of rows of sample container seats to tiers of the sample carrier assembly 559 is not required and other configurations of the sample carrier assembly 559 are contemplated. For example, as shown in, e.g., FIG. 1, the fourth tier T4 represents a sample processing station that contains some sample container seats but also seats for other types of containers.

It will be appreciated that, in some embodiments and in the illustrated embodiment, each sample carrier 550 includes a plurality of levels or tiers (tiers T1, T2, and T3), and the hub 540 forms an additional tier (tier T4) of the sample carrier assembly 559.

For the illustrated sample carrier assembly 559, the seats 551 in each tier T1-T4 each include a support 553 (FIG. 7) at a height corresponding to the height of its respective tier T1-T4. Each tier T1-T4 thus is capable of supporting the sample containers 80 mounted thereon at a corresponding height. As illustrated in FIG. 3, the first tier T1 supports a first set 81A of sample containers 80A at a first support height HS1, the second tier T2 supports a second set 81B of sample containers 80B at a second support height HS2, the third tier T3 supports a third set 81C of sample containers 80C at a third support height HS3, and the fourth tier T4 supports a third set 81D of sample containers 80D at a fourth support height HS4. A “set” of sample containers may comprise one or more sample containers.

As a result, the top ends 86 of the sample containers 80A are positioned at a first top end height HT1, the top ends 86 of the sample containers 80B are positioned at a second top end height HT2, the top ends 86 of the sample containers 80C are positioned at a third top end height HT3, and the top ends 86 of the sample containers 80D are positioned at a fourth top end height HT4 (FIG. 7). The second top end height HT2 is greater than the first top end height HT1, the third top end height HT3 is greater than the second top end height HT2, and the fourth top end height HT4 is greater than the third top end height HT3, so that top end heights HT1, HT2, HT3, HT4 are likewise tiered. Such an embodiment is appropriate when sample containers 80A, 80B, 80C, 80D are similarly sized, however the present disclosure envisions different top end heights at different tiers, in particular, if different sized sample containers are used.

In the illustrated embodiment, the supports 553 are lower walls upon which the bottom end 87 of the seated sample container 80 sits. However, it will be appreciated that alternative types of support features may be employed.

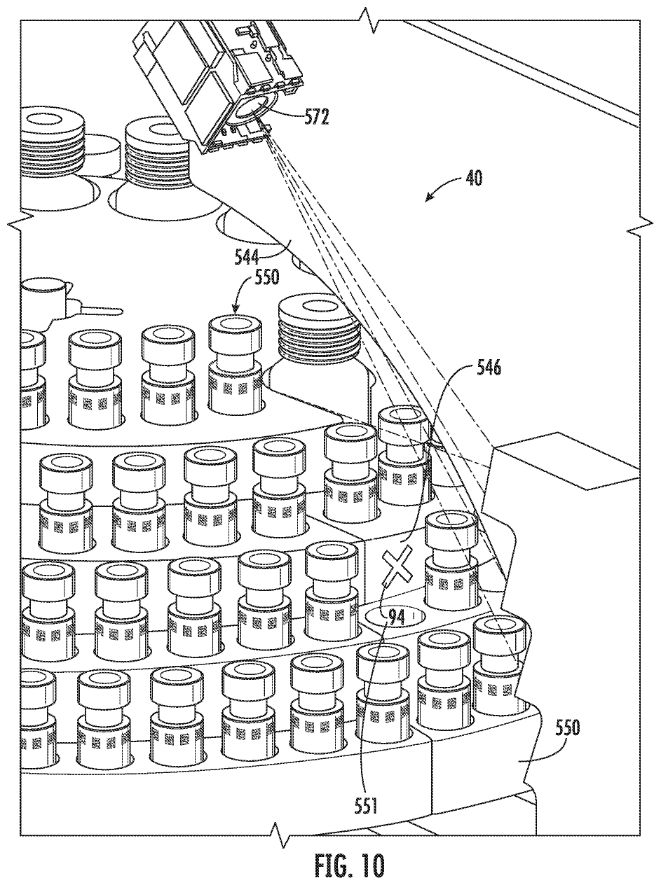

Each tier T1-T3 includes an upstanding wall 546 positioned behind (i.e., nearer the central axis Q) and above each seat 551 of the tier. Vacancy indicia or markers 94 (FIG. 10) are located on the upstanding walls 546. In the illustrated embodiment, the vacancy markers 94 include a plurality of visible “X” marks each positioned behind a respective individual seat 551. However, the vacancy markers 94 may take other forms, and may be in other locations based on the embodiment.

The sample analyzer system 40 can be used and operated as follows in accordance with methods of the present technology. The controller 52, the actuators, the barcode reader 572, the sampling system 520, and the analytical instrument 20 collectively serve as a control system operative to execute the methods.

The sample containers 80A-D are mounted in the slots 552 of the seats 551 of the sample carrier assembly 559. The sample containers 80A are each mounted in a respective one of the seats 551 of the first tier T1 (although as provided herein, not every seat will have a sample container 80A mounted therein). The sample containers 80B are each mounted in a respective one of the seats 551 of the second tier T2. The sample containers 80C are each mounted in a respective one of the seats 551 of the third tier T3.

In the illustrated embodiment, the fourth tier T4 comprises some seats for sample containers 80D that may be taken from one of the lower tiers and inserted in the seats in the fourth tier T4, and the fourth tier T4 may comprise seats for other types of containers such as containers 80X (FIG. 3) containing reagents, washing fluids (e.g., for cleaning probes), waste containers (e.g., for holding or storing, e.g., excess washing fluid or sample), etc. Some of the containers 80X may be of different size than sample containers 80. In such an embodiment, the fourth tier T4 may be viewed as a liquid handling or processing station PS (FIG. 3) for processing the samples that are in the sample containers in the lower tiers (e.g., T1, T2, T3) by moving such lower tier sample containers (e.g., 80A-C) to the fourth tier T4 for processing. In some embodiments, the processing station tier or location is separate and apart from the sample carriers (tiers) that comprise seats for the sample containers.

Each sample container 80A-D and its position in the sample carrier assembly 559 may be identified and registered or indexed in a sample container data memory associated with the controller 52. Each sample container 80 has a unique identity that is represented in its barcode 90. The sample carriers 550 may also be identified and their seats 551 individually registered or indexed in a sample carrier data memory.

In the illustrated embodiment, the sample containers 80A, 80B, 80C and 80D may be arranged in arcuate rows V1, V2, V3 and V4 corresponding to the sequential seat rows R1, R2, R3 and R4, respectively.

As discussed herein, the top ends 86 of the sample containers 80A-D may be sequentially progressively tiered. In the FIG. 7 embodiment, the top ends 86 of the sample containers 80D are positioned (at height HT4) above the top ends 86 of the sample containers 80C (at height HT3), thereby defining a vertical gap GT4 over each sample containers 80C between the height HT4 and the height HT3. The top ends 86 of the sample containers 80C are positioned (at height HT3) above the top ends 86 of the sample containers 80B (at height HT2), thereby defining a vertical gap GT3 over each sample containers 80B between the height HT3 and the height HT2. The top ends 86 of the sample containers 80B are positioned (at height HT2) above the top ends 86 of the sample containers 80A (at height HT1), thereby defining a vertical gap GT2 over each sample containers 80A between the height HT2 and the height HT1. As provided herein, not all sample carriers may have three tiers, and embodiments of sample carriers as disclosed herein may have two or more tiers. In some embodiments, the hub 540 may not be configured as an additional tier of the sample carrier assembly 559.

In some embodiments, each gap, e.g., GT2, GT3, GT4, has a height D11 (FIG. 7) above the top end 86 of the preceding sample container, e.g., 80A, 80B, 80C of at least about 7 mm and, in some embodiments, in the range of from about 10 mm to about 50 mm. Such gap may be determined (with reference to FIG. 1) based on one or more of the analytical instrument 20, positioning system 530, extraction/sampling system 520 and/or controller 52.

Moreover, for the illustrated sample carrier of the FIG. 7 embodiment, the indicia 90 of the sample containers 80D are positioned (at height HI4) above the height of the indicia 90 of the sample containers 80C (at height HI3), the indicia 90 of the sample containers 80C are positioned (at height HI3) above the height of the indicia 90 of the sample containers 80B (at height HI2), and the indicia 90 of the sample containers 80B are positioned above the height of the indicia 90 of the sample containers 80A (at height H11).

In some embodiments and as illustrated, the tops of the indicium 90 of the sample containers 80D are located at a height HI4 that is above the height HT3, the tops of the indicium 90 of the sample containers 80C are located at an indicia height HI3 that is above the top end height HT2, and the tops of the indicium 90 of the sample containers 80B are located at an indicia height HI2 that is above the top end height HT1, so that the indicia 90 of the sample containers 80D project above the top ends of the sample containers 80C, the indicia 90 of the sample containers 80C project above the top ends of the sample containers 80B, and the indicia 90 of the sample containers 80B project above the top ends of the sample containers 80A. In this case, at least a portion of each indicium 90 of the sample containers 80C is visibly exposed over the top of a sample container 80B, and at least a portion of each indicium 90 of the sample containers 80B is visibly exposed over the top of a sample container 80A, from a horizontal line of sight. In some embodiments, the difference D12 (FIG. 7) between the heights HI3 and HT2 and between the heights HI2 and HT1 is in the range of from about 7 mm to about 45 mm. In embodiments, the heights HT1-HT4 of the two or more tiers (e.g., T1-T4) may be considered and/or established in relation to properties of the visible indicia 90 (e.g., size, shape, height, location on sample container, etc.) to allow for a line of sight, horizontal or otherwise, that further allows the disclosed systems and methods to visually determine the presence or absence of sample in a given container 80. Such determination may be automatically performed using optics devices as otherwise provided herein, and the results of such determination may be provided to a user and/or other system component.

Generally, when it is desired to analyze a sample N (FIG. 2) in a selected one of the sample containers, e.g., 80A-D (referred to herein as the “target sample container”), the controller 52 operates the actuator to rotate the hub 540, and thereby the sample carrier assembly 559, about the rotation axis Q, and the controller 52 operates the sampling system 520 to extract a sample from the target sample container. The controller 52 can thereafter repeat the procedure to withdraw samples from other selected sample containers 80 in the sample carriers 550. As discussed herein, in some embodiments the controller 52 operates the autosampler 500 to move the target sample container from its seat 551 to a new location for processing (e.g., at the processing station PS). In other embodiments, the controller 52 may operate the autosampler 500 to withdraw the sample from the target sample container without removing the target sample container from its seat 551.

In use, it may be necessary or desirable to read the indicium 90 of the target sample container 80 and/or determine whether a sample container 80 is present at the target location (i.e., the corresponding seat 551). For this purpose, the sample carrier 550 is rotated to selectively position the associated sample carrier 550, and thereby the sample containers 80 therein, relative to the barcode reader 572, thereby placing the barcode reader 572 in a reading position with respect to the target sample container 80. In practice, the barcode reader 572 may be placed in a reading position with respect to multiple sample containers simultaneously via the mirrors 579A-D, as discussed herein.

While the system 40 is shown and described wherein the sample carrier 550 is moved relative to the barcode reader 572 and the sampling effector (e.g., sampling probe or robot end effector), in other embodiments the barcode reader 572 may be mounted for movement relative to the sample carrier assembly 559 and/or for movement with the sampling effector.

When the barcode reader 572 is in the reading position with respect to a (or multiple) target sample container 80, the barcode 90 of the target sample container(s) 80 is in the field of view of the barcode reader 572, as described in more detail below. The barcode reader 572 will read the barcode(s) 90 and send an (or multiple) output signal corresponding to the barcode(s) 90 to the controller 52. More particularly, in some embodiments, the barcode reader 572 (including the optical sensor 571) is configured to generate an electrical output signal(s) having voltage levels in a pattern corresponding to the barcode(s) 90 (or other visible indicium/indicia). The controller 52 is configured to receive and process the output signal(s). In some embodiments, the output signal(s) represents or embodies image data corresponding to the barcode(s) 90 of the target sample container(s) 80. The output signal(s) will be described hereinbelow with reference to image data; however, in some embodiments, the output signal(s) may represent or embody data other than image data, such as a one-dimensional data string.

In the illustrated system, the controller 52 will process the image data to determine the location of the barcode(s) 90 of the target sample container(s) 80 with respect to the sample carrier seats 551 and to decrypt the data embodied in the barcode 90. In some embodiments, the controller 52 programmatically and automatically processes the image data to determine said location and decrypt said data.

In this embodiment the controller 52 will also then execute an appropriate action depending on the acquired barcode data. For example, if the barcode(s) 90 of the target sample container(s) 80 confirms the target sample container(s) 80 is correct for sampling or other processing (e.g., properly identified and in the correct location), the controller 52 will then operate a robotic end effector to remove the sample container from the sample carrier 550, as described herein (e.g., to replace the sample container 80 in the processing station PS tier of the sample carrier assembly 559). The controller 52 may then operate an actuator to lower a probe tip into the target sample container to extract and transfer an aliquot of the sample in the sample container 80 to the analytical instrument 20. In other embodiments, the controller 52 may lower the probe tip into the sample container and extract the aliquot with the sample container retained in the seat 551 of its sample carrier 550.

If the controller 52 determines from the data acquired from the barcode reader 572 that a fault is present, the controller 52 will execute an alternative action. Such faults may include: a sample container 80 is not present in the target seat 551; a sample container 80 is present in the target seat 551 but the barcode 90 data is indeterminate; and/or the sample container 80 present in the target seat 551 is not the correct (e.g., expected) sample container 80. The absence of a sample container 80 from a seat 551 may be determined using a fiducial mark 94, as discussed herein. Alternative action may include halting the autosampling procedure, skipping the target sample container or seat and continuing to the next target sample container or seat, and/or issuing or logging a fault alert or report.

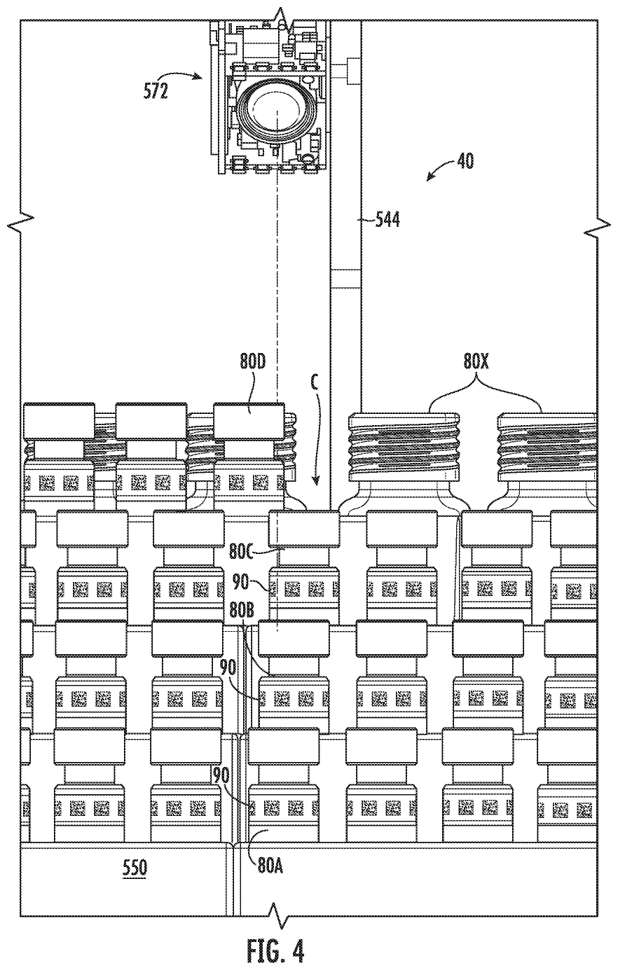

In some embodiments, when the barcode reader 572 is in a given or prescribed reading position with respect to the sample carrier assembly 559, the barcode reader 572 is thereby placed in a reading position with respect to a column or set C (FIGS. 4-6) of the sample containers 80 including a sample container in two or more of the rows, e.g., V1-V4. With reference to FIG. 8, it can be seen that the barcode reader 572 has a first line of sight LS1 to a sample container 80A in the first row V1, a second line of sight LS2 to a sample container 80B in the second row V2, a third line of sight LS3 to a sample container 80C in the third row V3, and a fourth line of sight LS4 to a sample container 80D in the fourth row V4.

In the reading position of FIG. 8 the line of sight LS2 to the sample container 80B extends over the adjacent intervening sample container 80A and through the vertical gap GT2. Likewise, the line of sight LS3 to the sample container 80C extends over the adjacent intervening sample container 80B and through the vertical gap GT3. Likewise, the line of sight LS4 to the sample container 80D extends over the adjacent intervening sample container 80C and through the vertical gap GT4.

For example, FIG. 8 shows the barcode reader 572 in a reading position relative to a column C of sample containers including a target sample container 80BT having a target barcode 90BT. The line of sight LS2 of the barcode reader 572 intersects the target barcode 90BT, thereby enabling the barcode reader 572 to read the target barcode 90BT.

The line of sight LS2 extends through the void or gap GT2 defined between the target barcode 90BT and an adjacent, intervening sample container 80AA that is disposed in the row V1 (in the lower tier T1), and over the intervening sample container 80AA. The intervening sample container 80AA is located laterally between the barcode reader 572 and the target barcode 90BT, but is located below the line of sight LS2 so that the view of the barcode reader 572 to the target barcode 90BT is not blocked by the intervening sample container 80AA.

Incident light rays emanating from the target barcode 90BT (e.g., ambient light reflected from the visible indicium 90BT) travel generally along the line of sight LS to the reception window 575. In some embodiments, the light rays travel substantially parallel to the reception axis of the barcode reader 572. The image is detected by the optical sensor 571 and processed by the barcode reader 572 as described herein.

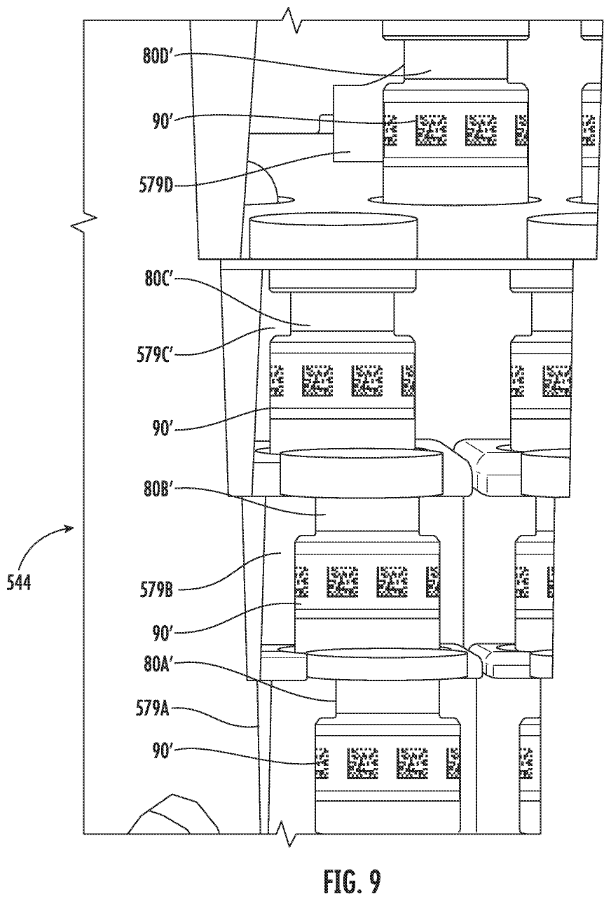

FIG. 9 shows the view from the perspective of the optical sensor 571. As shown in FIG. 9, each mirror 579A-D reflects an image 80A′-80D′ of a respective sample container 80A-80D, including an image 90′ of the indicia 90 of the sample container 80A-80D.

In some embodiments (e.g., as shown) and with reference to FIG. 8, the sample container monitoring system 570 employs one or more mirrors 579 to beneficially configure the lines of sight LS1-LS4. The barcode reader 572 is located and mounted on the arm 544 above the heights of the mirrors 579A-D. The lines of sight LS1-LS4 of the barcode reader 572 are each directed at and reflected by the reflecting surfaces of the mirrors 579A-D, respectively. Each line of sight LS1-LS4 includes a first segment LSB extending from the barcode reader 572 to the respective associated mirror 579A-D, and a second segment LSM extending from the associated mirror 579A-D to the barcode indicium 90 of the respective target sample container 80A-D. The segment LSM extending from the mirror 579A-D to the target sample container 80A-D is oriented with respect to the target sample container 80A-D as discussed herein such that the segment LSM extends through the corresponding gap GT2-GT4.

The mirrors 579A-D can enable the designer to use angles for better reading of the barcodes on the target sample container(s) and/or the sample carrier, and/or for using machine vision as discussed herein. In particular, the mirrors 579A-D can be positioned relative to the barcode reader 572 and the staggered sample containers 80A-D to provide line of sight LS1-LS4 distances of focal lengths that are all within the prescribed depth of field of the barcode reader 572. In some embodiments, the barcode reader 572 and the mirrors 579A-D are positioned relative to the indicia 90 of the sample containers 80A-D such that the total line of sight LS1-LS4 distances are all substantially the same (e.g., within 5% of one another).

The mirrors 579A-D may also allow for more desirable placement or packaging of the barcode reader 572.

In some embodiments, the indicium 90 is configured to ensure that no matter how the sample container 80 is rotated about its vertical axis relative to the optical (e.g., barcode) reader 572, a sufficient amount of the indicium 90 is in the field of view of the optical reader 572 to enable the optical reader 572 to capture and decode the indicium 90. In some embodiments, each indicium 90 is a barcode that is repeated circumferentially about the associated sample container 80 as many times as necessary to ensure that no matter how the sample container 80 is rotated about its vertical axis relative to the barcode reader 572, a sufficient amount of the indicium 90 is in the field of view of the barcode reader 572 to enable the barcode reader 572 to capture and decode the barcode. For example, the indicium 90 may include a series of substantially identical or repeating barcode patterns 92 (FIG. 2) circumferentially distributed about the sample container 80.

In the illustrated embodiment, the controller 52 decrypts the target sample container barcode (or visible indicium) so that the data contained therein may be associated with the respective (target) sample container and can thereafter be associated with such sample container (and hence, the sample therein) throughout the procedure.

In some embodiments, the barcode reader 572 is also used to identify missing sample containers. The system 570 may accomplish this using the vacancy markers 94 as fiducials. In the event that no sample container is seated in one of the seats 551 (referred to herein as the target seat) corresponding to an intended target sample container, the corresponding line of sight LS1-LS4 of the barcode reader 572 will intersect the vacancy marker 94 on the upstanding wall 546 at a location directly behind the target seat because a sample container is not present to block the view of the vacancy marker 94. The barcode reader 572 will send an output signal corresponding to acquired image of the vacancy marker 94 to the controller 52. The controller 52 will receive and process the image data from the output signal. The controller 52 will determine from the image data that the seat corresponding to the scanned vacancy marker 94 is empty of any sample container (i.e., a missing sample container).

Traceability of samples is extremely important in analytical laboratories. Visible indicium such as the barcodes 90 give the sample containers 80 (and the samples contained therein) a unique identification that may be logged into a database for tracking. High throughput labs run many samples per day through analytical instruments. These labs often use autosamplers that arrange many samples in an array. Reading, e.g., barcodes on sample containers in a densely packed two-dimensional array is typically challenging because there is little spacing between sample containers, preventing reading of the barcodes. In some known apparatus, each selected sample container is removed from the sample carrier and moved to a position where a barcode reader can achieve a line of sight to conduct a reliable reading of the barcode. This method increases the cost of the autosampler and can contribute to sample contamination because the sample containers must be touched.

For the illustrated embodiments, the configuration of the autosampler 500 and the monitoring system 570 enable the barcode reader 572 to read the barcode 90 of each target sample container 80 even though the target sample container may be located within a dense array of the sample containers. The arrangement of the autosampler 500 clearly exposes the barcode of a target sample container to the barcode reader even though the target barcode would otherwise have been obfuscated by one or more other sample containers positioned in the sample carrier 550 between the barcode reader and the target sample container.

As a result, the barcode 90 of each sample container 80 can be scanned by the barcode reader 572 without removing the sample container 80 from its seat 551 or rotating the sample container 80. The autosampler 500 does not require that the sample containers be touched or moved, thus reducing the associated cost and reducing the risk of sample cross-contamination.

In some embodiments, the system 40 simultaneously reads the barcodes 90 of sample containers 80 located in different tiers T1-T4 from one another. This is enabled by the provision of the multiple, spatially distributed lines of sight LS1-LS4. For example, in some embodiments, the system 40 will rotate the sample carrier assembly 559 while simultaneously reading the sample containers 80 on two or more tiers T1-T4. In this way, the system 40 can batch scan and register the entire sample carrier assembly 559 or a subset thereof (e.g., as discussed herein).

Embodiments of the controller 52 may take the form and be configured as discussed herein with regard to the controller 52 with suitable programming to execute the operations and methods disclosed herein. The operations described herein may be programmatically and automatically executed by the controller 52.

In some embodiments, the sample carriers 550 do not have prescribed, individually partitioned slots to receive each sample container. Instead, each sample carrier may include prescribed locations that the sample containers assume when the sample carrier is filled.

The optical sensor 571 (e.g., barcode reader 572) and the sample carriers 550 or sample carrier assembly 559 may be moved relative to one another in ways other than those described herein to selectively position the optical sensor in a reading location with respect to each target sample container. For example, an autosampler may be configured to move the sample carrier relative to a barcode (or other visible indicium) reader, to move the barcode (or other visible indicium) reader relative to the sample carrier (e.g., as described for the autosampler 500), or a combination of the two.

The sampling system 520 of the autosampler 500 may be configured to extract or withdraw samples from the sample containers 80 in any suitable manner. In some embodiments, the sampling system 520 withdraws the sample from the sample container while the sample container is disposed in the sample carrier assembly 559 (e.g., in a sample carrier 550 or the hub 540). In some embodiments, the sampling system 520 includes a probe that is inserted into the sample container 80 and a negative pressure is induced in the probe to aspirate the sample into the probe. The aspirated sample may then be transferred to an inlet of the analytical instrument from the probe. For example, the aspirated sample may be transferred through a conduit between an outlet of the probe and an inlet of the analytical instrument 20. Alternatively, the probe may be inserted into an inlet (e.g., an injection port) of the analytical instrument 20 and the sample then dispensed from the probe into the inlet. In further embodiments, the probe (e.g., a pin probe) may be inserted into and removed from the sample container 80 such that a droplet of the sample adheres to the probe, and the probe is then moved to an inlet of the analytical instrument 20 to deposit the droplet.

In some embodiments, the sample container 80 is removed from the sample carrier assembly 559 and transferred to another location or withdrawal station, where the sampling system then withdraws the sample from the sample container. In this case, the withdrawal station may be a part of the analytical instrument 20, part of the sample carrier assembly 559, or a supplemental station/location. For example, in some embodiments, after reading and processing a sample container's barcode 90, the sample container 80 is transferred (e.g., by a robotic end effector) to a withdrawal station where a probe aspirates or otherwise removes a sample from the sample container, and then transfers the sample to the analytical instrument 20 as described herein (e.g., via a conduit or injection port). In some embodiments, the withdrawal station may withdraw the sample from the sample container without a probe (e.g., by flowing a sample carrier gas through the sample container (e.g., a thermal desorption tube)). In some of the illustrated embodiments, the withdrawal station is the processing station PS (FIG. 3) located on the top tier of the sample carrier assembly 559.

In the illustrated embodiments, operations described herein can be executed by or through the controller 52. Actuators and other devices of the system 40 can be electronically controlled. According to some embodiments, the controller 52 programmatically executes some, and in some embodiments all, of the actions described. According to some embodiments, the movements of the actuators are fully automatically and programmatically executed by the controller 52.

In some embodiments, the controller 52 programmatically and automatically executes each of the reading the barcodes 90 and processing of the image data to determine the locations and data contents of the barcodes 90. In some embodiments, the controller 52 programmatically and automatically executes each of the operation of the autosampler device 500 described herein.

Embodiments of the controller 52 logic may take the form of an entirely software embodiment or an embodiment combining software and hardware aspects, all generally referred to herein as a “circuit” or “module.” In some embodiments, the circuits include both software and hardware and the software is configured to work with specific hardware with known physical attributes and/or configurations. Furthermore, controller logic may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or other storage devices.

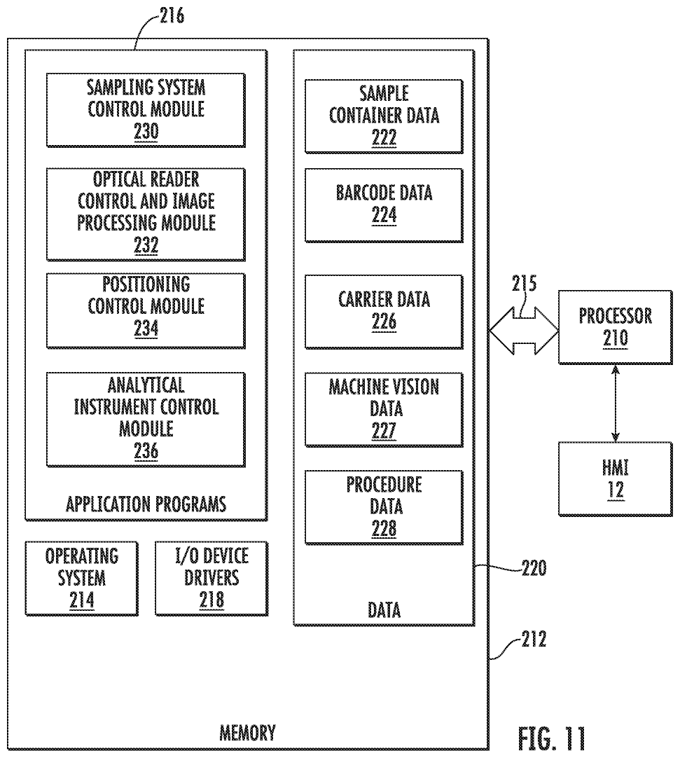

FIG. 11 is a schematic illustration of a circuit or data processing system 202 that can be used in the controller 52. The circuits and/or data processing systems may be incorporated in a digital signal processor 210 in any suitable device or devices. The processor 210 communicates with the HMI 12 and memory 212 via an address/data bus 215. The processor 210 can be any commercially available or custom microprocessor. The memory 212 is representative of the overall hierarchy of memory devices containing the software and data used to implement the functionality of the data processing system. The memory 212 can include, but is not limited to, the following types of devices: cache, ROM, PROM, EPROM, EEPROM, flash memory, SRAM, and DRAM.

FIG. 11 illustrates that the memory 212 may include several categories of software and data used in the data processing system: the operating system 214; the application programs 216; the input/output (I/O) device drivers 218; and data 220.

The data 220 can include equipment-specific data. FIG. 11 also illustrates that the data 220 can include sample container data 222, barcode data 224, sample carrier data 226, and procedure data 228. The sample container data 222 can include data relating to or representing characteristics of each sample container 80, including a unique identifier (e.g., serial number), name, and description of an analyte contained in the sample container 80, for example. The barcode data 224 can include a registry indexing or cross-referencing barcodes to the serial numbers of the sample containers 80, for example. The sample carrier data 226 can include seat location data representing spatial or geometric layout or positions of the seats 551 relative to the sample carrier assembly 559 and the platform 510. The procedure data 228 can include data representing a protocol or sequence of steps to execute the procedures described herein (including an analytical sequence, for example).

FIG. 11 also illustrates that application programs 216 can include a sampling system control module 230 (to control the sampling system 520), an optical reader control and image processing module 232 (to control the sample container monitoring system 570 (including the optical sensor 571)), a positioning control module 234 (to control the actuators of a probe or end effector of the sampling system 520), and an analytical instrument control module 236 to control the analytical instrument 20.

As will be appreciated by those of skill in the art, the operating system 214 may be any operating system suitable for use with a data processing system. The I/O device drivers 218 typically include software routines accessed through the operating system 214 by the application programs 216 to communicate with devices such as I/O data port(s), data storage and certain memory components. The application programs 216 are illustrative of the programs that implement the various features of the data processing system and can include at least one application, which supports operations according to embodiments of the present technology. Finally, the data 220 represents the static and dynamic data used by the application programs 216, the operating system 214, the I/O device drivers 218, and other software programs that may reside in the memory 212.

As will be appreciated by those of skill in the art, other configurations may also be utilized while still benefiting from the teachings of the present technology. For example, one or more of the modules may be incorporated into the operating system, the I/O device drivers or other such logical division of the data processing system. Thus, the present technology should not be construed as limited to the configuration of FIG. 11, which is intended to encompass any configuration capable of carrying out the operations described herein. Further, one or more of the modules can communicate with or be incorporated totally or partially in other components, such as the controller 52.

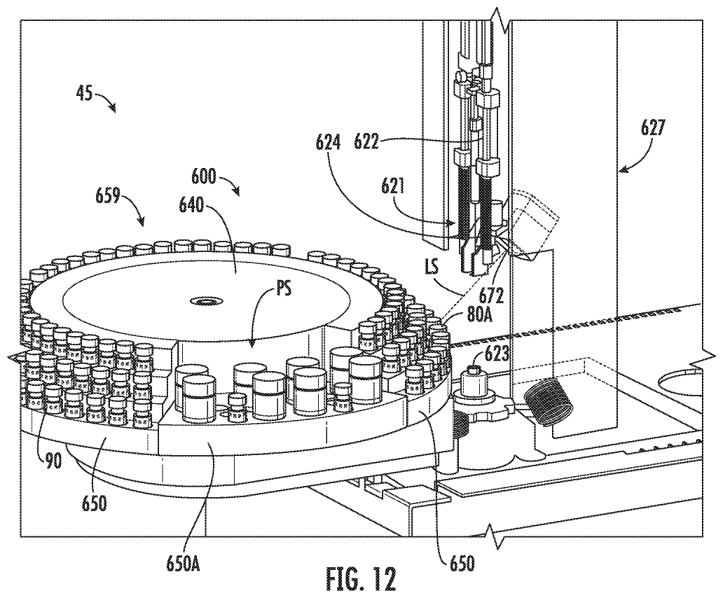

With references to FIGS. 12-14, a sample analyzer system 45 according to further embodiments of the technology is shown therein. The system 45 includes an autosampler 600 and a sampling system 620. The sampling system 620 includes a sampling station 627, which includes a movable sampling head 621. The sampling head 621 carries a probe 624. The sampling head 621 may include a syringe 622, and the probe 624 may be a needle. The system 45 and the autosampler 600 may be constructed and operate as discussed for the system 40 and the autosampler 500, except as discussed herein.

The illustrated sample carrier assembly 659 includes a hub 640 and a plurality of sample carriers 650 mounted thereon. In the illustrated embodiment, the processing station PS is located on a removable carrier 650A instead of at the top of the hub 640. However, it will be appreciated that a sample carrier assembly and processing station as described herein for the system 40 may be used instead, for example.

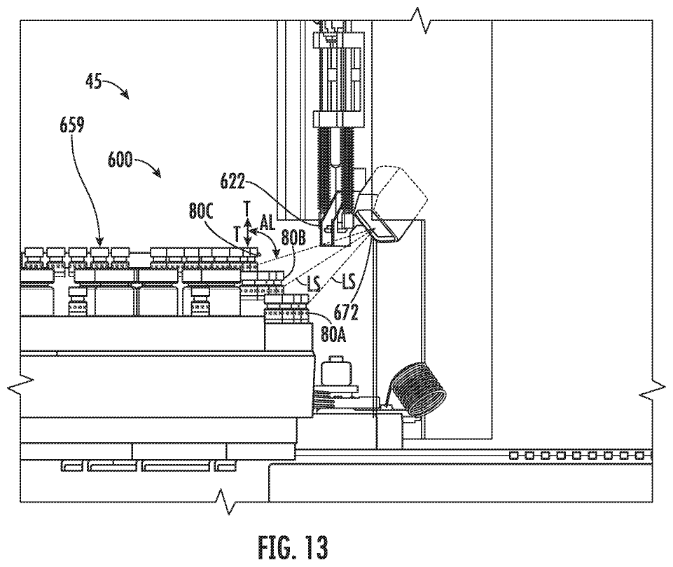

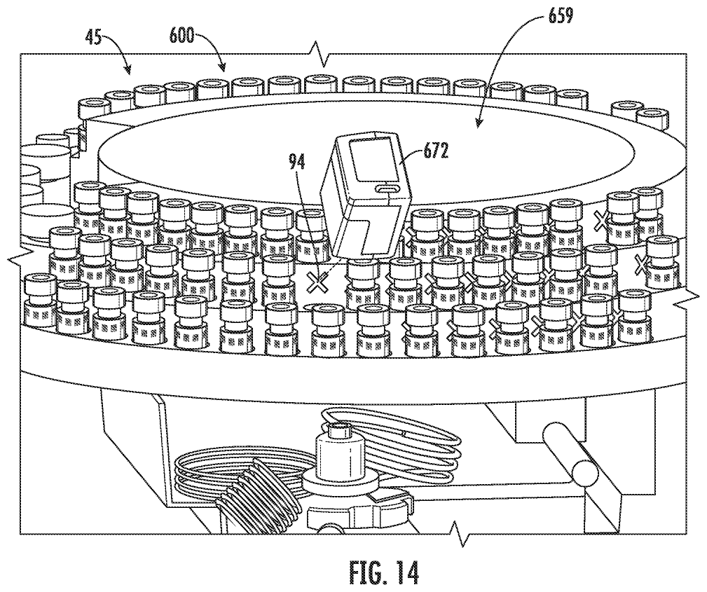

In the system 45, the barcode reader 672 is mounted on the sampling head 621 for movement therewith. The barcode reader 672 has a direct, non-reflected line of sight or lines of sight to the sample containers 80A-C in the three respective tiers T1-T3 of the sample carrier assembly 659. The barcode reader 672 is mounted above and laterally offset from the sample containers 80A-C so that the line of sight LS extends at an oblique angle AL (FIG. 13) to the heightwise axes T-T (FIG. 2) of the sample containers 80A-C. The system 45 may also employ fiducial marks 94 (FIG. 14) to detect vacant seats.

The system 45 may be configured and operated such that the probe 624 withdraws a sample from a selected sample container 80 (e.g., a sample container located in the PS processing station PS (FIG. 3)) and dispenses the withdrawn sample into an injection port 623 for introduction to and analysis by an associated analytical instrument (not shown).

Sample analyzer systems, autosamplers, and sample container monitoring systems as described herein and in accordance with embodiments of the invention (e.g., the autosampler 500) can enable quick and convenient bulk or batch scanning of the indicium (e.g., 90) of the sample containers (e.g., the sample containers 80) using the barcode reader (e.g., the barcode reader 572). Bulk scanning can greatly reduce sequence setup time. The scan data can be compared to a pre-existing registry or list of the sample containers in the sample carrier (e.g., a registry pre-populated by an operator designating the identity of each sample holder positioned in and assigned to each given designated location in the sample carrier) to confirm or verify that the sample containers are properly positioned after they are loaded onto the instrument. Alternatively or additionally, the scan data may be used to populate such a registry or list after the sample containers have been loaded in the sample carrier. This may relieve the operator of the need to manually scan and designate and register each sample container to each sample carrier position. In some embodiments, a controller (e.g., the controller 52) programmatically and automatically executes some or all of the bulk scanning, comparing and populating as described herein. In some embodiments, the sample container monitoring system 570 uses the barcode reader 572 to continuously scan and read the sample containers 80 in bulk as the sample carrier assembly 559 is rotated relative to the barcode reader 572.

While the autosamplers 500, 600 are shown and described with a sample carrier assembly 559 having arcuate or circular rows of seats and sample containers, the sample carriers and sample containers may be otherwise arranged with tiered rows, and the sample container monitoring system may be configured and operated as described for the sample container monitoring system 570. For example, the sample carrier seats and sample containers may be arranged in substantially rectilinear rows having ascending heights from row to row.

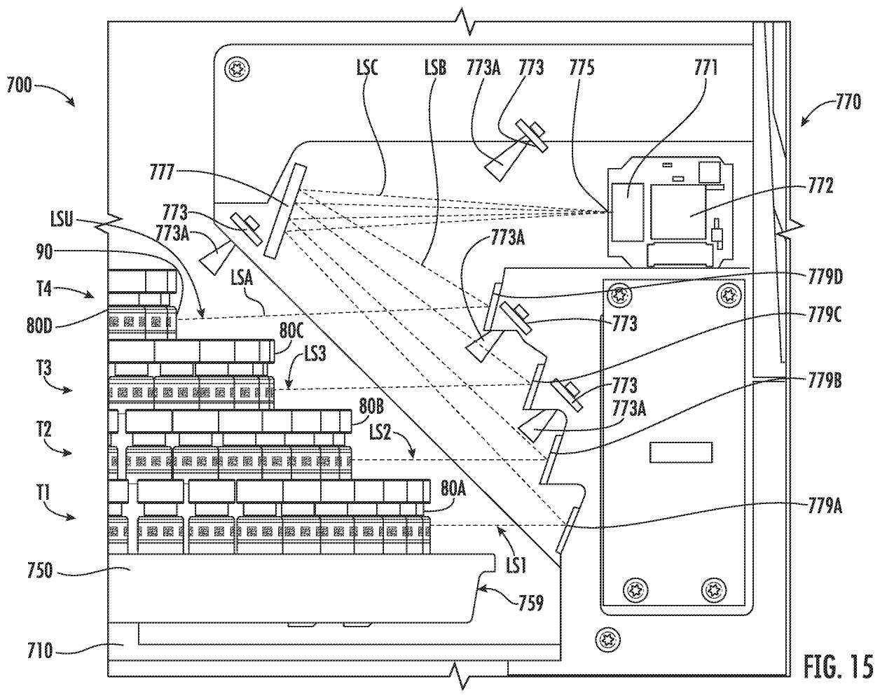

With reference to FIG. 15, an autosampler 700 according to further embodiments of the technology is shown therein. The autosampler 700 may be used in place of the autosampler 500 in the sample analyzer system 40, for example. The autosampler 700 includes a platform 710, a sample container monitoring system 770, and a sample carrier assembly 759 (including one or more tiered sample carriers 750) corresponding to, and operating in the same manner as, e.g., the components 510, 570, and 559, respectively, except as discussed herein. For the illustrated embodiment that also uses bar codes as the visible indicium and hence a corresponding bar code reader for reading the same, the sample container monitoring system 770 includes a barcode reader 772 corresponding to the barcode reader 572. The autosampler 500 may further include a sampling system and a positioning system corresponding to the sampling system 520 and the positioning system 530.

The autosampler 700 differs from the autosampler 500 in that the sample container monitoring system 770 further includes a folding mirror 777 optically interposed between the optical reception window 775 of the optical sensor 771 of the optical reader 772 and the tier-specific mirrors (hereinafter, the tier mirrors) 779A-D. As discussed herein, the tier mirrors beneficially configure the lines of sight LS1-LS4 from the optical reader 772 to the containers 80A-D on the four tiers T1-T4, respectively.

Each line of sight LS1-LS4 is directed at and reflected by the folding mirror 777, from there directed (by the folding mirror 777) at a respective one of the tier mirrors 779A-D, and reflected by the tier mirror 779A-D to the corresponding tier T1-T4. Accordingly, each line of sight LS1-LS4 includes a first segment LSC extending from the optical reader 772 to the folding mirror 777, a second segment LSB extending from the folding mirror 777 to a respective tier mirror 779A-D, and a third segment LSA extending from the tier mirror 779A-D to the barcode indicium 90 of the respective sample container 80A-D. It will be appreciated that each line of sight (i.e., the path of light rays from target to the barcode reader reception window) is folded twice by the mirrors 777, 779A-D.

The combined mirrors 777, 779A-D can enable the designer to use desired angles for reading the barcodes on the sample containers and/or the sample carrier, and/or for using machine vision as discussed herein, while also permitting flexible placement of the optical reader 772 relative to the sample carrier 750. For example, the optical reader 772 can be positioned in the platform 710 (e.g., a self-contained module) at a location radially spaced apart from the sample carrier 750 while still achieving line of sight distances for each of the lines of sight LS1-LS4. The mirrors 777, 779A-D can be positioned relative to the optical reader 772 and the staggered sample containers 80A-D to provide line of sight LS1-LS4 distances that are all within the prescribed depth of field of the optical reader 772. In some embodiments, the mirrors 777, 779A-D are positioned relative to the optical reader 772 and the staggered sample containers 80A-D such that the focal distances between the optical reader 772 and the sample containers 80A-D in different tiers T1-T4 are substantially the same (i.e., the focal lengths/distances for the different tiers are substantially equalized). In some embodiments, the mirrors 777, 779A-D are positioned relative to the optical reader 772 and the staggered sample containers 80A-D such that the distances of the lines of sight LS1-LS4 are all within 5% of one another. This equalized focal length/distance may be particularly beneficial when the optical reader 772 is used to read sample containers 80A-D on different tiers T1-T4 simultaneously.

In some embodiments, the sample container monitoring system 770 includes an integral illumination system that provides supplemental light to assist the optical reader 772 in reading the visible indicium on the sample containers 80A-D. With reference to FIG. 15, the sample container monitoring system 770 includes a plurality of light sources 773 positioned in the frame 710. The light sources each generate light 773A that is incident on the sample containers 80A-D and reflected to the optical reader 772 via the mirrors 777, 779A-D. In some embodiments and as shown in FIG. 15, a plurality of light sources 773 are provided and strategically positioned to each direct light primarily to a respective one of the tiers T1-T4. In this manner, the tier-to-tier illumination can be made more uniform.

In some embodiments, the light sources 773 are LEDS. In some embodiments, the light sources 773 are red LEDS.

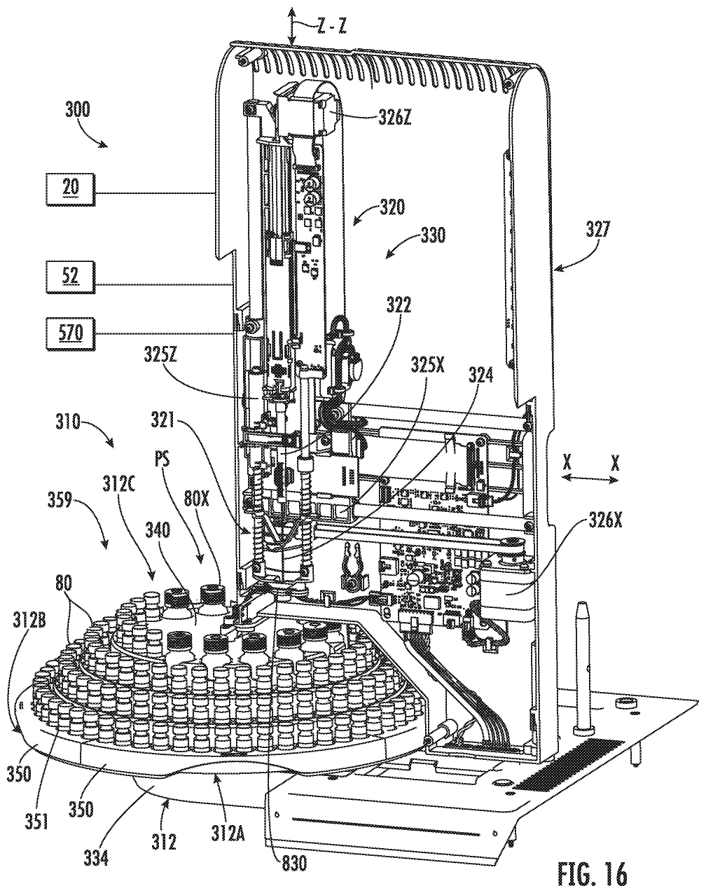

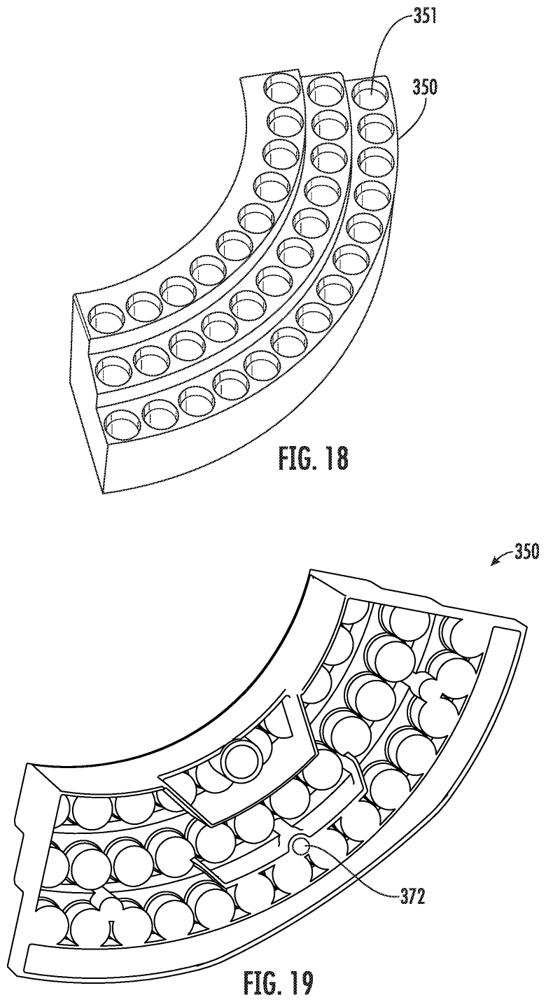

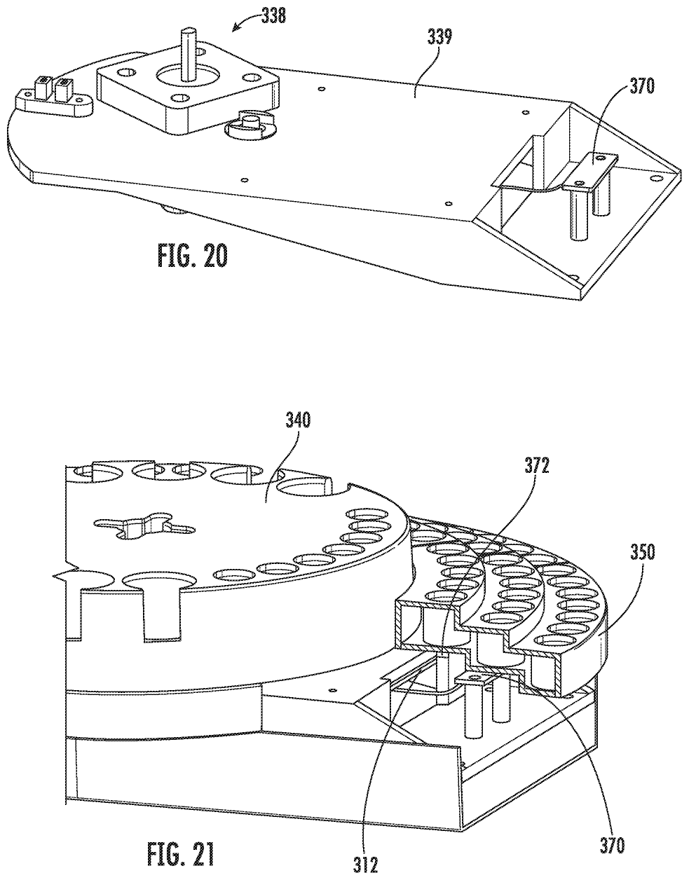

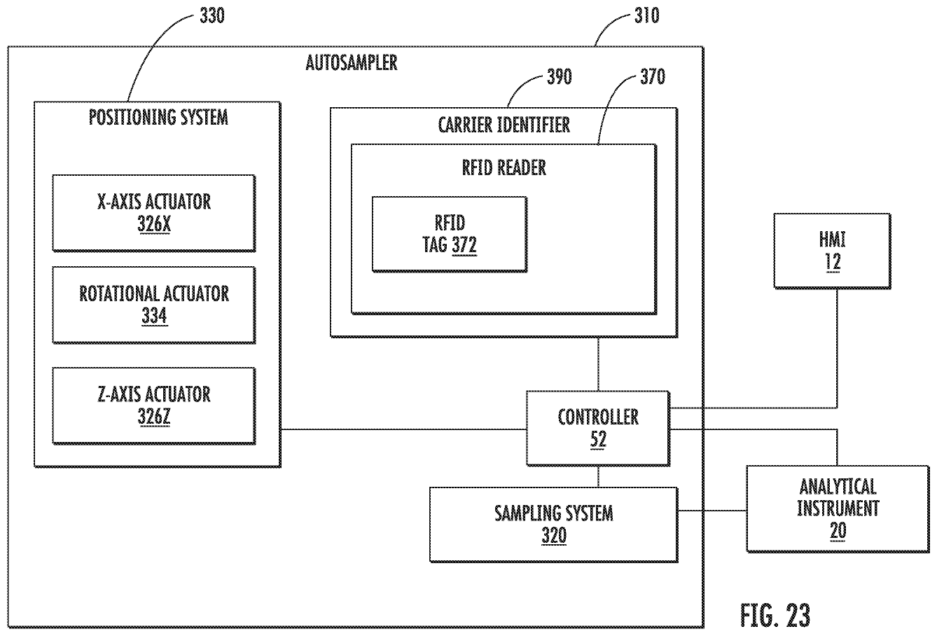

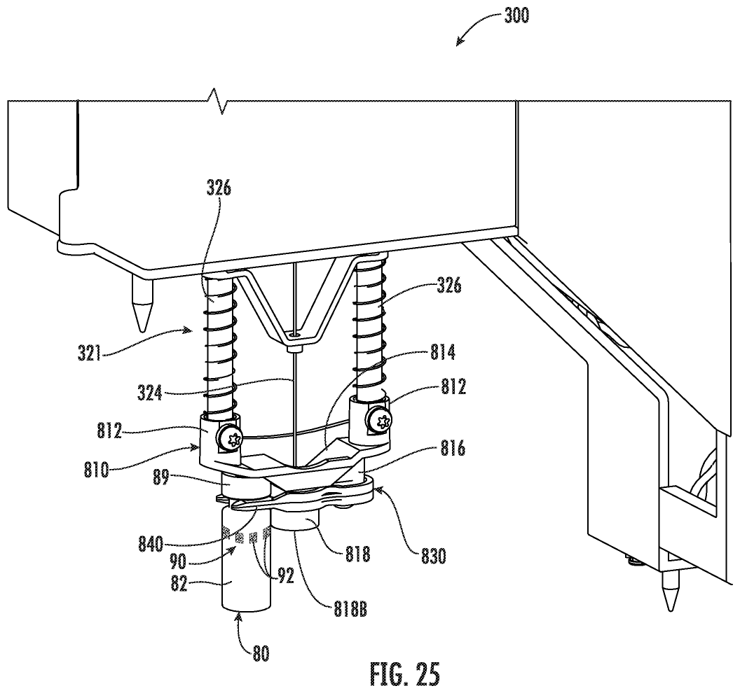

In further embodiments and as shown in FIGS. 16-22, a sample analyzer system 300 includes an automated sampler device or autosampler 310, an analytical instrument 20, and a controller 52. The autosampler 310 includes a positioning system 330. The autosampler 310 includes a sample carrier identifier 390 (FIG. 23) that identifies a location, presence and/or configuration of a particular sample carrier based on RFID signals received from a RFID tag 372 (FIGS. 19, 21) as detected by an RFID reader 370 (FIG. 21) on a stationary portion of the autosampler 310 (see FIGS. 18-21, described herein). The illustrated autosampler 310 includes a platform 312 that defines four sample carrier positions 312A-312D. The illustrated autosampler 310 also includes a central or hub 340 at the center of the sample carrier positions 312A-312D, and a respective outer tray or sample carrier 350 positioned in each of the four sample carrier positions 312A-312D. In some embodiments, the sample carriers 350 are each individually removable from the platform 312 and the hub 340.

The sample carriers 350 are capable of holding sample containers 80 in a plurality of sample carrier seats 351. The hub 340 and the sample carriers 350 collectively form a sample carrier assembly 359. The sample carrier assembly 359 may be generally constructed as described herein for the sample carrier assembly 559, with a tiered configuration. In some embodiments, the hub 340 is also capable of holding sample containers 80 in a plurality of sample carrier seats 351. In some embodiments, the autosampler 310 includes a sample carrier monitoring system 570 (shown schematically in FIG. 16) corresponding to the sample container monitoring system 570 of FIG. 1.

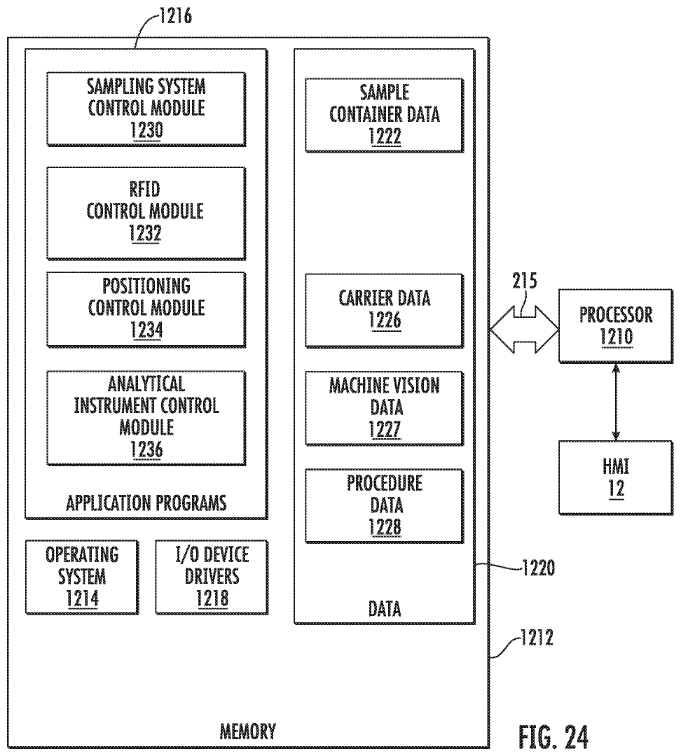

With reference to FIG. 22, the illustrated sampling system 320 includes a sampling station 327, which includes a sampling head 321. The sampling head 321 includes a probe 324. In some embodiments, the sampling head 321 may include a syringe 322, and the probe 324 may be a needle.

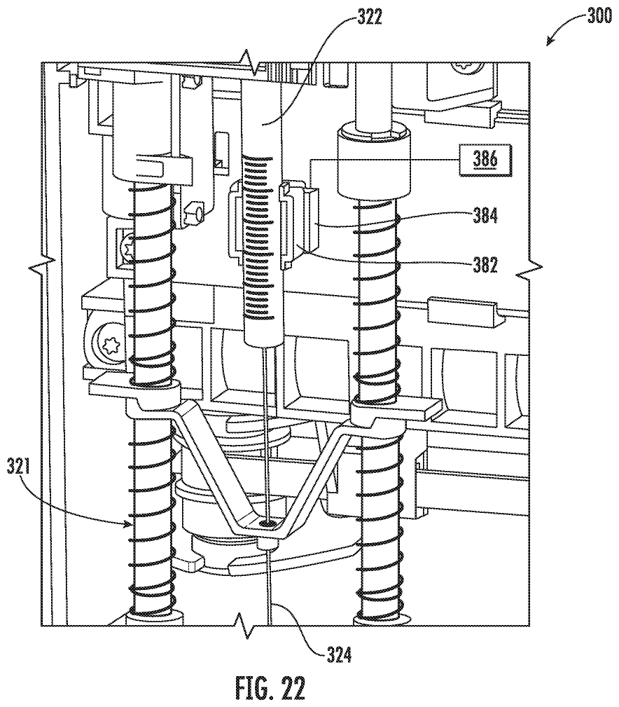

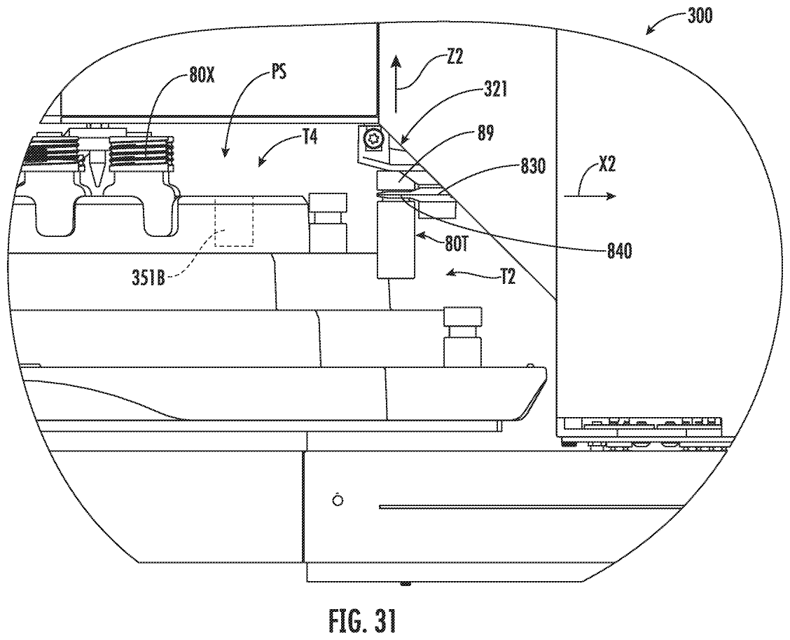

The sampling head 321 is mounted on a Z-axis carriage 325Z. The Z-axis carriage 325Z is mounted on an X-axis carriage 325X. The positioning system 330 includes an X-axis actuator 326X operable to move or translate the carriage 325X (and thereby the sampling head 321) in opposing directions X1, X2 along the X-axis, and a Z-axis actuator 326Z operable to move or translate the carriage 325Z (and thereby the sampling head 321) in opposing directions Z1, Z2 along the Z-axis (FIGS. 29 and 30). The positioning system 330 further includes a rotational actuator 334 including an arm 339 with a rotating chuck 338 (FIG. 20) for rotating the platform 312 to thereby position the sample containers 80 in a given position with respect to the sampling head 321. Thus, the positioning system 330 may be configured to move either the sampling head 321 or the platform 312/sample containers 80.

Each sample carrier 350 is generally marked by sample position number (1-n). That is, the sample positions of the sample containers 80 are defined by the configuration of the sample carrier 350. It should be understood that any suitable number of sample carrier positions and/or sample positions may be used. Therefore, a plurality of sample carriers 350 each loaded with sample containers 80 may be mounted on the platform 312 at defined sample carrier positions (e.g., sample carrier positions 312A-312D) and accessed by the autosampler 310. The plurality of sample carriers 350 may have different configurations of sample containers 80, such as a various numbers of containers, various levels of containers, various spacing between containers, and/or various sizes of containers.

The analytical instrument 20 may be any suitable apparatus for processing a sample or samples. The analytical instrument 20 may include one or more of systems for analyzing a sample in a container such as a tube, including but not limited to an atomic absorber, an inductively coupled plasma (ICP) instrument, a gas chromatography system, a liquid chromatography system, a mass spectrometer, a thermal measurement instrument such as a calorimeter or thermogravimetric analyzer, a food (e.g., grain, dough, flour, meat, milk, etc.) analyzer, or combinations of any of the foregoing, for example.

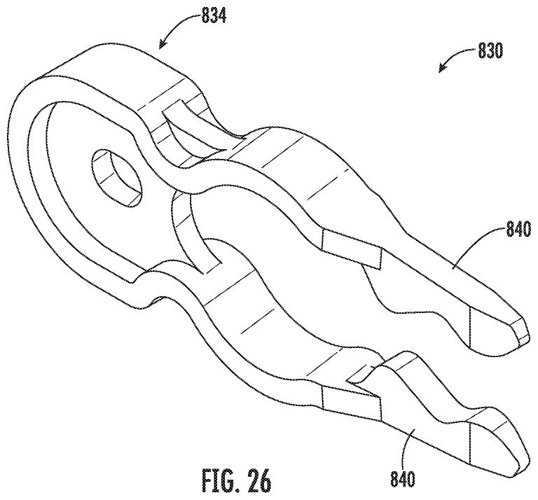

As shown in FIG. 19, each sample carrier 350 has an RFID tag 372 mounted thereon. As shown in FIG. 21, an RFID reader 370 is mounted on the arm 339 or other stationary component of the autosampler 310. In this configuration, the platform 312 rotates into a position such that the RFID reader 370 is adjacent to an RFID tag 372 on one of the sample carriers 350 when the same are occupying positions 312A-312D on the platform 312. Signals from the RFID tag 372/RFID reader 370 may be used to control the autosampler 310 as described with respect to FIGS. 23-24.

In one embodiment, the RFID tags 372 and reader 370 are passive RFID components such that the RFID tag 372 on the sample carrier 350 does not generally require a dedicated battery or power source; however, in some configurations, active RFID systems may be used. The RFID reader 370 is in communication with the sample carrier identifier 390. In this configuration, when the platform 312 rotates so that one of the RFID tags 372 is adjacent the stationary RFID reader 370, the RFID reader 370 activates the adjacent RFID tag 372 and receives a signal from the RFID tag 372 that identifies the RFID tag 372 and the associated one of the sample carrier positions 312A-312D. In some embodiments, there may be multiple RFID readers 370.

The signal from the RFID tag 372 may be conveyed to the sample carrier identifier 390. The sample carrier identifier 390 may determine in which one of the positions 312A-312D the sample carrier 350 has been placed based on which RIFD reader 370 is sending the signal. In addition, the signal may include information regarding the configuration of the sample carrier 350, including a number and arrangement of the sample containers 80.

The sample carrier identifier 390 may provide information regarding the configuration and/or location of the sample carrier 350 from the RFID tag 372 to the controller 52 for controlling the sampling system 320, the positioning system 330 and the analytical instrument 20. The sample carrier identifier 390 may provide information regarding the configuration and/or location of the sample carrier 350 to the HMI 12, which can communicate the information to a user so that the user can confirm the information and correct any errors (FIGS. 23-24).

Generally, when it is desired to analyze the sample in a selected one of the sample containers 60 (referred to herein as the “target sample container”), the controller 52 operates the X-axis actuator 326X for moving the sampling head 321 along the X-axis, and operates the Z-axis actuator 326Z for moving the sampling head 321 along the Z-axis. The controller 52 can further operate the rotational actuator 334 including the arm 339 and rotating chuck 338 (FIG. 20) for rotating the platform 312 to thereby position the sample containers 80 in a given position with respect to the sampling system 320. Accordingly, the controller 52 can operate the positioning system 330 to move either the sampling head 321 or the platform 312/sample containers 80. The controller 52 may then operate the actuators 326X, 326Z, 336, the arm 339 and rotating chuck 338 such that the probe 324 is positioned directly over the target sample container 80. The controller 52 then operates the Z-axis actuator 326Z to lower the carriage 325Z along the Z-axis and into the target sample container 80. The controller 52 then operates the sampling system 320 to withdraw a sample N from the chamber of the target sample container 80 and transfer the sample to the analytical instrument 20.

The controller 52 then operates the actuator 336 to raise the carriage 325Z along the Z-axis and thereby remove the probe 324 from the target sample container 80. The controller 52 can thereafter repeat the foregoing procedure to withdraw samples from other selected sample containers 80 in the sample carrier 350.

The controller 52 (FIG. 23) may be any suitable device or devices for providing the functionality described herein. The controller 52 may include a plurality of discrete controllers that cooperate and/or independently execute the functions described herein. The controller 52 may include a microprocessor-based device, including, for example, a computer, tablet or smartphone. Accordingly, the controller 52 may utilize the configuration of the sample carrier 350 that is received from the sample carrier identifier 390 based on information from the signal of the RFID reader 370 to identify the configuration of the sample carrier 350. The controller 52 may then execute an appropriate action depending on the acquired data from the RFID reader 370.

The sampling system of the disclosed autosampler may be configured to extract or withdraw samples from the sample containers 80 in any suitable manner. In some embodiments, the sampling system withdraws the sample from the sample container while the sample container is disposed in the sample carrier. In some embodiments, the sampling system (e.g., the sampling system 320) includes a probe 324 that is inserted into the sample container 80 and a negative pressure is induced in the probe to aspirate the sample into the probe. The aspirated sample may then be transferred to an inlet of the analytical instrument from the probe. For example, the aspirated sample may be transferred through a conduit between an outlet of the probe and an inlet of the analytical instrument. Alternatively, the probe may be inserted into an inlet (e.g., an injection port) of the analytical instrument and the sample then dispensed from the probe into the inlet. In further embodiments, the probe (e.g., a pin probe) may be inserted into and removed from the sample container such that a droplet of the sample adheres to the probe, and the probe is then moved to an inlet of the analytical instrument to deposit the droplet.

In some embodiments, the sample container is removed from the sample carrier and transferred to another location or withdrawal station, where the sampling system then withdraws the sample from the sample container. In this case, the withdrawal station may be a part of the analytical instrument or a supplemental station. For example, in some embodiments, the sample container is transferred (e.g., by a robotic end effector) to a withdrawal station where a probe aspirates or otherwise removes a sample from the sample container, and then transfers the sample to the analytical instrument as described herein (e.g., via a conduit or injection port). In some embodiments, the withdrawal station may withdraw the sample from the sample container without a probe (e.g., by flowing a carrier gas through the sample container (e.g., a thermal desorption tube)).

Operations described herein can be executed by or through the controller 52. The actuators 326X, 326Z, 336, the arm 339 and rotating chuck 338 and other devices of the system 300 can be electronically controlled. According to some embodiments, the controller 52 programmatically executes some, and in some embodiments all, of the steps described. According to some embodiments, the movements of the actuators are fully automatically and programmatically executed by the controller 52.

Embodiments of the controller 52 logic may take the form of an entirely software embodiment or an embodiment combining software and hardware aspects, all generally referred to herein as a “circuit” or “module.” In some embodiments, the circuits include both software and hardware and the software is configured to work with specific hardware with known physical attributes and/or configurations. Furthermore, controller logic may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or other storage devices.

FIG. 24 is a schematic illustration of a circuit or data processing system 1202 that can be used in the controller 52. The circuits and/or data processing systems may be incorporated in a digital signal processor 1210 in any suitable device or devices. The processor 1210 communicates with the HMI 12 and memory 1212 via an address/data bus 215. The processor 1210 can be any commercially available or custom microprocessor. The memory 1212 is representative of the overall hierarchy of memory devices containing the software and data used to implement the functionality of the data processing system. The memory 1212 can include, but is not limited to, the following types of devices: cache, ROM, PROM, EPROM, EEPROM, flash memory, SRAM, and DRAM.

FIG. 24 illustrates that the memory 1212 may include several categories of software and data used in the data processing system: the operating system 1214; the application programs 1216; the input/output (I/O) device drivers 1218; and data 1220.

The data 1220 can include equipment-specific data. FIG. 24 also illustrates that the data 1220 can include sample container data 1222, sample carrier data 1226, machine vision data 1227, and procedure data 1228. The sample container data 1222 can include data relating to or representing characteristics of each sample container 80, including a unique identifier (e.g., serial number), name, and description of an analyte contained in the sample container 80, for example. The sample carrier data 1226 can include a registry indexing or cross-referencing sample carrier configurations to the sample carrier signals received from the RFID readers 370. The sample carrier data 1226 can include seat location data representing spatial or geometric layout or positions of the sample containers 80 relative to the sample carrier 350 and the frame 312. The machine vision data 1227 can include algorithms, reference images, and other data to assist in interpreting the image data. The procedure data 1228 can include data representing a protocol or sequence of steps to execute the procedures described herein (including an analytical sequence, for example).

FIG. 24 also illustrates that application programs 1216 can include a sampling system control module 1230 (to control the sampling system 320), and RFID control module 1232 (to control the sample carrier identification system (including the RFID reader 370)), a positioning control module 1234 (to control the actuators 326X, 326Z, 336, the arm 339 and rotating chuck 338), and an analytical instrument control module 1236 to control the analytical instrument 20.

As will be appreciated by those of skill in the art, the operating system 1214 may be any operating system suitable for use with a data processing system. The I/O device drivers 1218 typically include software routines accessed through the operating system 1214 by the application programs 1216 to communicate with devices such as I/O data port(s), data storage and certain memory components. The application programs 1216 are illustrative of the programs that implement the various features of the data processing system and can include at least one application, which supports operations according to embodiments of the present technology. Finally, the data 1220 represents the static and dynamic data used by the application programs 1216, the operating system 1214, the I/O device drivers 1218, and other software programs that may reside in the memory 1212.

As will be appreciated by those of skill in the art, other configurations may also be utilized while still benefiting from the teachings of the present technology. For example, one or more of the modules may be incorporated into the operating system, the I/O device drivers or other such logical division of the data processing system. Thus, the present technology should not be construed as limited to the configuration of FIG. 24, which is intended to encompass any configuration capable of carrying out the operations described herein. Further, one or more of the modules can communicate with or be incorporated totally or partially in other components, such as the controller 52.

It should be further understood that any suitable configuration of the sample carrier may be used, including various shapes.

In some embodiments, the RFID tag may be configured to provide additional information and/or functions. For example, passive RFID transponder(s) or tag(s)s may include temperature sensors that are powered by the RFID transponder or reader when queried by the RFID reader such that a temperature measurement is made when the RFID reader reads the RFID tag. In this configuration, the temperature of the sample carrier may be measured so that temperature control (cooling or heating) of the trays may be measured. Temperature sensing RFID tags are available, for example, from Phase IV Engineering, Inc. (Boulder, Colo., USA).

Additional data from that autosampler may further be used and correlated with data from the RFID tag and reader, including the sensor data. For example, autosamplers that utilize barcode readers, machine vision, user inputs via an HMI or other data gathering devices may correlate data from multiple sources to identify sample carriers, track temperature, and the like.

It should be understood that any suitable configuration of RFID tag and/or reader may be used, and RFID tags and readers may be positioned in other locations on the autosampler and/or sample carrier. For example, as shown in FIG. 22, an RFID tag 382 is mounted on the syringe 322 and an antenna PCB or RFID reader 384 is mounted on the autosampler. The RFID reader 384 is in communication with a syringe monitor 386 for receiving, storing and analyzing data from the RFID reader 384 and tag 382. For example, in some embodiments, the RFID reader 384 connects to a transceiver card, which connects to the controller or syringe monitor 386, such as by a coax cable to allow movement of the syringe 322. In some embodiments, the RFID tag includes sensing capability, including temperature sensing.

The RFID reader 370 is illustrated on a stationary portion of the autosampler 310 (e.g., the arm 339) with the platform 312 rotating into a position such that the RFID reader 370 is adjacent one of the sample carrier positions 312A-312D that includes an RFID tag 372 when the sample carrier 350 on the platform 312. However, it should be understood that the RFID reader 370 may be positioned on a movable element of the autosampler 310, for example, such as a scanning unit or arm with the RFID reader 370 mounted thereon so that the scanning arm is configured to move the RFID reader 370 to the plurality of sample carrier positions and read a signal from the at least one RFID tag 382 on the sample carrier 350. For example, the scanning arm may be a rotatable scanning arm mounted on the frame 312.

Thus, the RFID tag 382 may include a sensor, such as a temperature sensor, for sensing the temperature of the syringe 322. In some embodiments, the RFID tag 382 is relatively large in order to accommodate the temperature sensor and may be a curved shape to fit in closer contact with the syringe 322.

Although embodiments according to the present invention are described herein with respect to RFID tags and readers, it should be understood that other devices may be used for collecting information and/or identifying a position and/or configuration of a sample carrier or syringe, including but not limited to, a barcode reader for reading a barcode on the sample carrier or syringe, magnets with reed switches, and electrical grounding techniques.

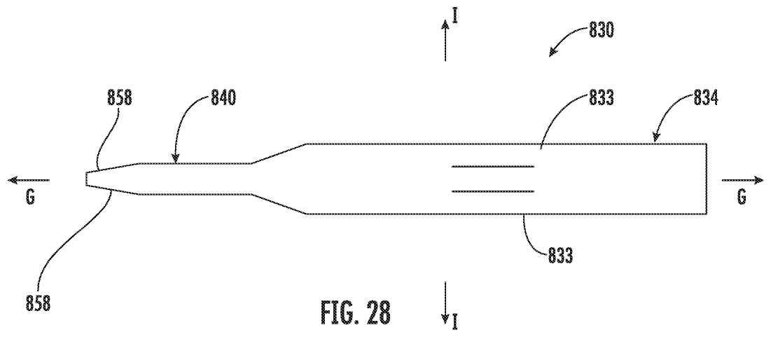

In some embodiments and with reference to FIGS. 16 and 25-32, a sample analyzer system as disclosed herein may include an autosampler having a gripper configured to releasably capture sample containers and transport the sample containers to and/or from a sample carrier, such as, for example, to/from a seat in the sample carrier to the processing station PS. In some embodiments, the gripper is integrated with a sampling head for movement therewith. In some embodiments, the gripper is passive, as discussed below. For example, the sample analyzer system 300 of FIG. 16 includes a gripper 830 that serves as an end effector for handling the sample containers 80. The gripper 830 is mounted on the sampling head 321 for movement therewith relative to the sample carriers 350 and the hub 340. Accordingly, in some embodiments, the gripper 830 is moved along with the syringe 322 and the needle 324.

The sampling head 321 includes opposed struts 326 and a yoke or support member 810. The struts 326 are mounted on the Z-axis carriage 325Z.

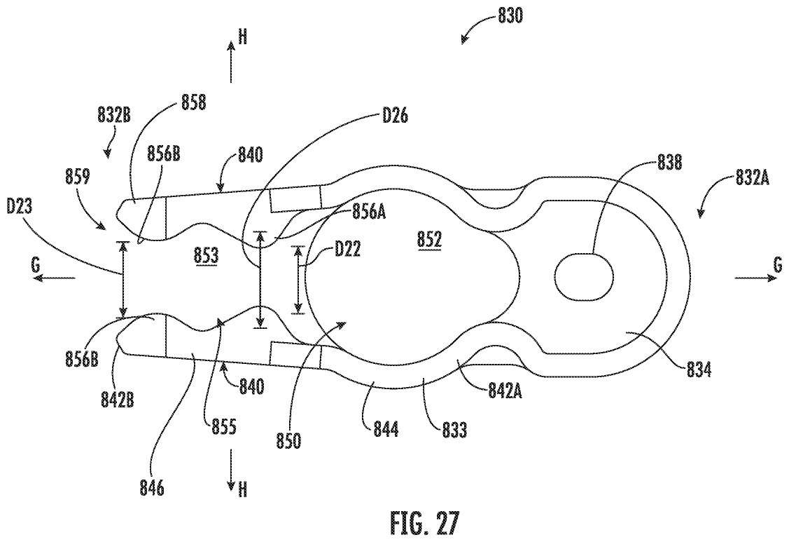

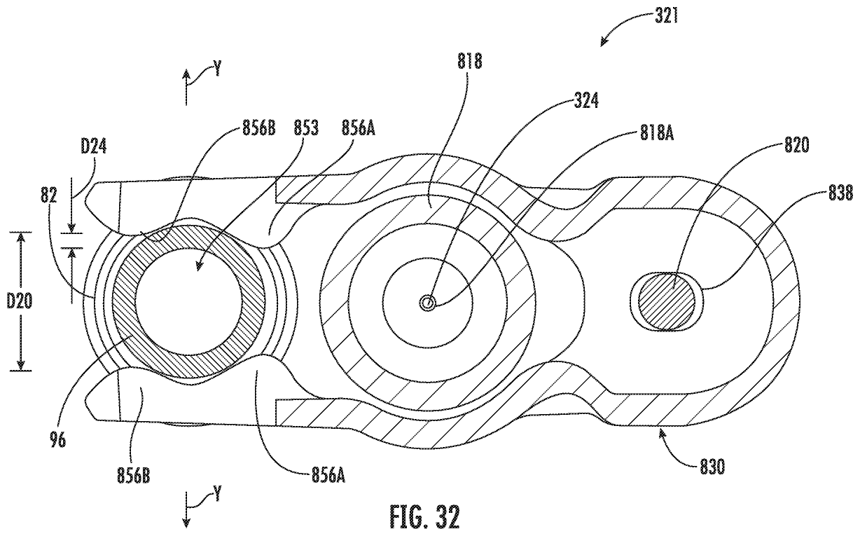

The support member 810 (FIG. 25) includes opposed strut mount features 812, a crossbar 814, a gripper mount feature 816, and a needle guide 818. A needle guide aperture 818A (FIG. 32) is defined in the needle guide 818 to receive the needle 324. The lower end of the needle guide 818 may include a container engagement feature or face 818B. A fastener opening (not visible in the drawings) is provided in the gripper mount feature 816.

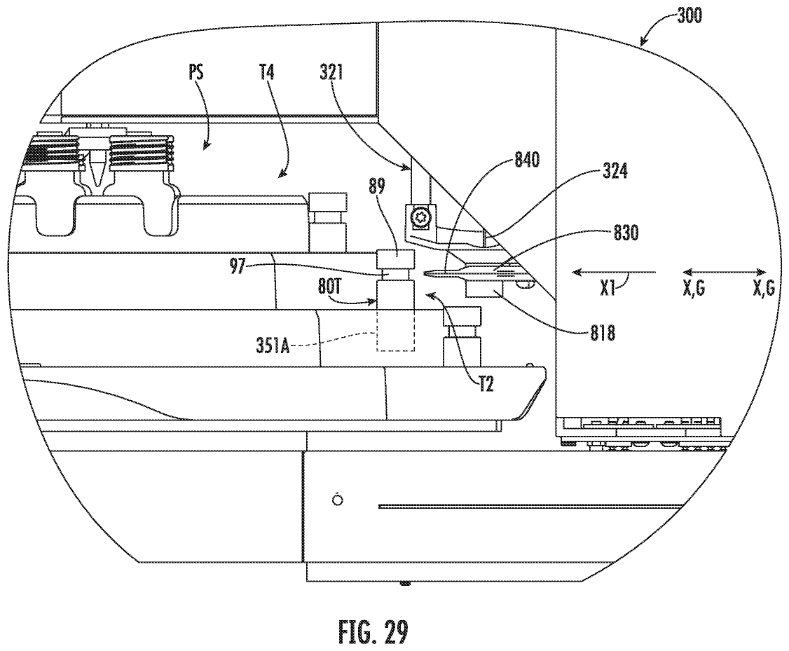

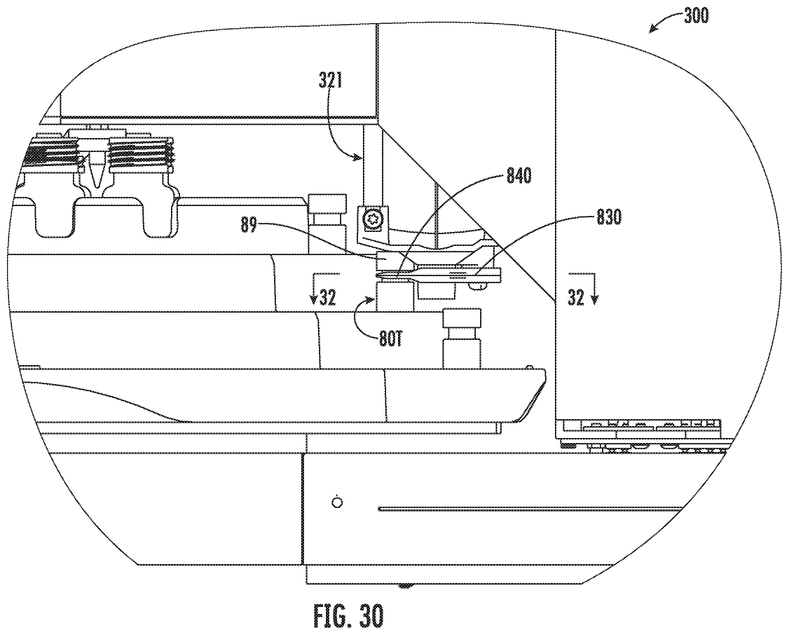

The gripper 830 has a lengthwise axis G-G (FIG. 29), a proximal end 832A, and a distal end 832B. The gripper 830 has a base 834 on the proximal end 832A, and a pair of opposed jaws or fingers 840 extending distally from the base 834 to the distal end 832B. The fingers 840 define longitudinally extending gripper slot 850 that terminates at a distal opening 859 at the distal end 832B. The fingers 840 are spaced apart along a first transverse or lateral axis H-H (FIG. 27) perpendicular to the lengthwise axis G-G. Opposed flanges 833 project upwardly and downwardly from the fingers along a second transverse or vertical axis I-I (FIG. 28).

The base 834 of the illustrated gripper includes a fastener hole 838.

In the illustrated embodiment, each finger 840 extends from a proximal end 842A at the base 834 to a tip or distal end 842B at the distal opening 859. Each finger 840 includes a proximal section 844 and a distal section 846.

The gripper slot 850 includes a needle guide receiving section 852 defined between the finger proximal sections 844, and a sample container receiving section 853 defined between the finger distal sections 846. The fingers 840 define a laterally tapered inlet section 854 from the opening 859 to the sample container receiving section 853. The fingers 840 include proximal shoulders 856A and distal shoulders 856B that project laterally inward to define a gripper seat 855 in the sample container receiving section 853. The leading (i.e., distal) ends of the fingers 840 include upper and lower ramped faces 858 that taper or slope toward the distal ends 842B.

The gripper 830 may be formed of any suitable material or materials. According to some embodiments, at least the fingers 840 are formed of a compliant, resilient material. In some embodiments, the gripper 830 is formed of a polymeric material. According to some embodiments, the gripper 830 formed of a material comprising nylon, although other suitable materials may be used. According to some embodiments, the material of the gripper 830 has a Young's Modulus in the range of from about 2 GPa to about 4 GPa. According to some embodiments, the gripper 830 is molded. In some embodiments, the gripper 830 is unitary and, in some embodiments, is monolithic.

The gripper 830 is secured to the gripper mount feature 816 by a fastener 820 (FIG. 32) that extends through the openings 816A, 838. The gripper mount 816 of the support member 810 mates with the base 834 to provide stability. The needle guide 818 is received in the needle guide receiving section 852. In inner diameter of the needle guide receiving section 852 may be sized so that the needle guide 818 does not interfere with the movement of the fingers 840.

In some embodiments, the gripper 830 is secured to the support member 830 in a manner that enables an operator to easily replace the gripper 830 in the event the gripper 830 is damaged or a different size of gripper 830 is desired. This may enable the gripper 830 to be a replaceable and/or customizable component of the autosampler 310.

The fingers 840 are attached or joined to the base 834 at their proximal ends 842A and free at their distal terminal ends 842B so that the fingers 840 are cantilevered from the base 834 in a substantially horizontal orientation. Moreover, the fingers 840 are free to be resiliently deflected in opposed lateral directions Y (FIG. 32) along the lateral axis H-H.

In some embodiments, in use, the controller 52 operates the autosampler 310 as follows to move and process a target sample container 80T. The target sample container 80T is constructed described above and as shown in FIG. 2 for the sample container 80. The target sample container 80T has a lower section having an outer diameter that is reduced or smaller than the outer diameter of an adjacent upper section, so that an annular container groove, channel, relief, or slot 97 is defined about the lower section below the upper section. In the illustrated target sample container 80T, the smaller outer diameter lower section is a neck 96 of the vessel 82, and the larger outer diameter upper section is the end cap 89. However, it will be appreciated that the gripper 830 may be used with sample containers of other suitable constructions. For example, the container slot 97 may be defined by integral shoulders or flanges on the vessel 82 or the cap 89. In some embodiments, and in the case of the target sample container 80T, the slot 97 is bounded above (by the end cap 89) and below (by a shoulder 82A of the lower section of the vessel 82 below the neck 96). However, in other embodiments, the slot 97 may be bounded only by the upper section (e.g., the body and neck of the sample container vessel may have the same outer diameter).

The distance D22 (FIG. 27) between the proximal shoulders 856A and the distance D23 between the distal shoulders 856B are each less than the outer diameter D20 (FIG. 32) of the neck 96. In some embodiments, the distances D22 and D23 are each at least about 2 mm less than the outer diameter D20.

In an example procedure and with reference to FIG. 29, the target sample container 80T is disposed in a seat 351A on the second tier T2. The controller 52 operates the rotation actuator 334 to position the seat 351A and the target sample container 80T in radial alignment with the sampling head 321. The controller 52 operates the X-axis actuator 326X and the Z-axis actuator 326Z to position the gripper 830 at the height of the container slot 97, but horizontally offset (along the X-axis) from the target sample container 80T, as shown in FIG. 29. The gripper inlet 854 and the distal end 852B face the sample container 80T.

The controller 52 then operates the X-axis actuator 326X to drive the sampling head 321 toward (in direction X1; FIG. 29) the target sample container 80T until the gripper 830 engages the target sample container 80T to capture the target sample container 80T in the gripper seat 855, as shown in FIGS. 25, 30 and 32. More particularly, the gripper 830 is progressively translated or slid onto the sample container 80T in the direction X1 such that the neck 96 enters through the inlet 859, laterally outwardly displaces the resilient fingers 840 in directions Y (FIG. 32). More particularly, the fingers 840 are forced to flex, bend, or deflect at their proximal ends 842A (e.g., by pivoting) and/or along the lengths of the fingers 840 such that the fingers 840 flare apart along the axis H-H. The controller 52 continues to operate the X-axis actuator 326X to drive the sampling head 321 in the direction X1 until the neck 96 finally enters and remains in the gripper seat 855. After the distal shoulders 856B pass over the neck 96, the fingers 840 snap back or elastically return toward their relaxed state.

During the step of forcing the gripper 830 onto the neck 96 of the target sample container 80T, the sample carrier seat 351A holds the sample container 80T to prevent the sample container 80T from moving away from the gripper 830 as the gripper 830 is forced onto the neck 96. The ramped faces 858 and the taper of the inlet 854 help to direct the neck 96 into the seat 855 without binding or displacing the sample container 80T.

In some embodiments, the gripper 830 is a parallel gripper constructed and implemented such that the deflection of the finger 840 occurs substantially only in the G-G/I-I plane. The flanges 833 reinforce the fingers 840 to prevent or resist the fingers 840 from being twisted or deflected out of the G-G/I-I plane.

The neck 96 is thereby captured in the seat 855 by the shoulders 856A, 856B. The shoulders 856A, 856B effectively interlock with the neck 96 to prevent or limit relative movement between the sample container 80T and the gripper 830 along the axis G-G. In some embodiments, the relaxed inner diameter D26 (FIG. 27) of the seat 855 is less than the outer diameter D20 (FIG. 32) of the neck 96 so that the fingers 840 continue to exert a persistent spring load or bias against the neck 96. In some embodiments, each finger 840 remains outwardly deflected a distance D24 (FIG. 32) from its empty position in the range of from about 1 mm to about 2 mm.

As discussed above, in some embodiments the slot 97 is defined between the sample container vessel shoulder 82A and the end cap 89. In this case, the neck 96 is also captured in the seat 855 by the interlock between the fingers 840 and these features.

With the sample container 80T captured in the gripper 830, the controller 52 then operates the Z-axis actuator 326Z to raise the sampling head 321 and thereby lift the sample container 80T out of the sample carrier seat 351A, as shown in FIG. 31. The inner diameter D26 of the seat 855 is less than the outer diameter D28 (FIG. 2) of the end cap 89, so that the sample container 80T cannot fall through the seat 855 of the gripper 830. The controller 52 may then operate the Z-axis actuator 326Z, the X-axis actuator 326X, and/or the rotation actuator 334 to deposit the sample container 80T where desired.

For example, in some embodiments, the controller 52: operates the Z-axis actuator 326Z to raise (in direction Z1) the sample container 80T above the top tier T4; operates the rotation actuator 334 to radially align a target seat 351B on the top tier T4 with the X-axis; operates the X-axis actuator 326X to translate the sample container 80T to a position directly above the target seat 351B; and then operates the Z-axis actuator 326Z to lower the sample container 80T into the target seat 351B. Once the sample container 80T is seated in the target seat 351B (or any other desired seat 351), the controller 52 operates the X-axis actuator 326X to translate the sampling head 321 (and thereby the gripper 830) linearly in direction X2 (FIG. 31) along the X-axis away from the seat 351B. Because the sample container 80T is held by the seat 351B, the gripper 830 is thereby pulled off of and away from the sample container 80T in an opposite progression from that described for grasping the sample container 80T with the gripper 830. The sampling head 321 may thereafter be used as desired to execute a process (e.g., aspirating a sample, etc.). It will be appreciated that the foregoing description of the movements of the target sample container 80T refers to the movements of the sampling head 321, with which the gripper 830 and the sample container 80T captured by the sample container 80T move.

In some embodiments, the sample containers 80 are stored in the sample carrier assembly lower tiers and delivered to the top tier T4 (the processing station PS) of the sample carrier assembly 359 to be operated on by the sampling head 321. The processing may include multiple phases (e.g., washing and rinsing the needle 324 and syringe 322, aspirating a sample from the sample container, injecting the sample into an injection port, etc.) that are executed on the processing station PS. Once the sample container 80 has been processed, the sampling head 321 and gripper 830 can be operated to return the sample container to a lower tier seat 351. Containers 80X containing wash fluid, rinse fluid, waste, etc. may be held in seats in the processing station PS.

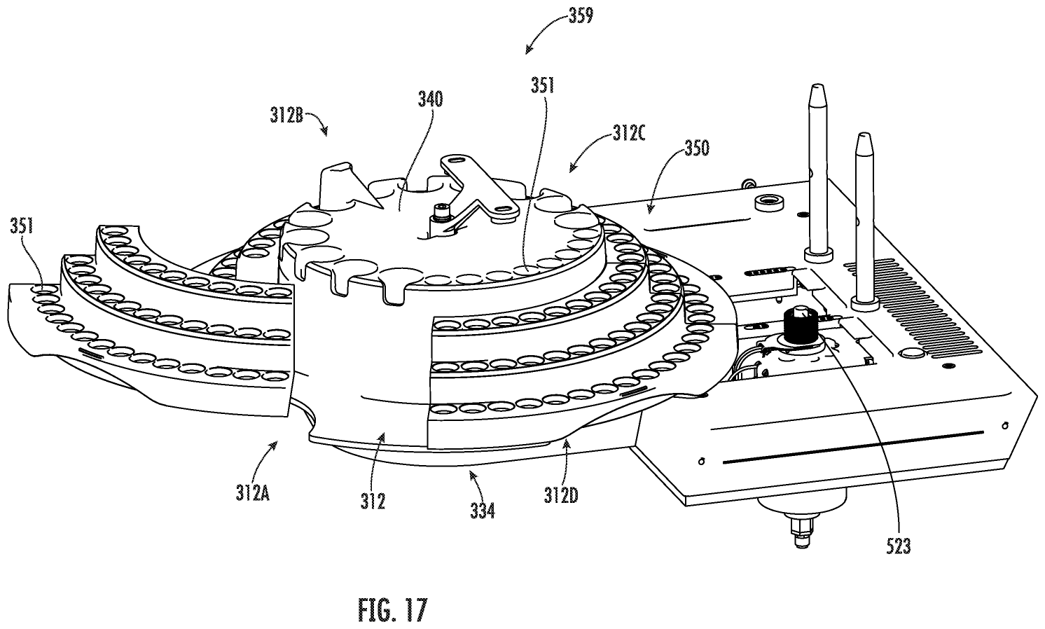

For example, according to some embodiments, seats 351 of the hub 340 are populated with a sample container 80X containing washing solution, a sample container 80X containing rinse fluid, and a sample container 80X to receive waste fluid. One or more of the seats 351 of the hub 340 are reserved (i.e., empty) to receive a sample container 80T. The top of the hub 340 is thereby configured to serve as a processing station PS. In such an embodiment, the sampling head 321 and gripper 830 are used to bring each target sample container 80T from its seat in a sample carrier 350 and deposit the target sample container 80T in a seat 351 of the processing station PS. The probe 324 is then aligned with the target sample container 80T, lowered and inserted into the target sample container 80T, and used to extract a sample from the target sample container 80T. The probe 324 is then moved to a position aligned over an injection port 523 (FIG. 17), inserted into the injection port 523, and used to dispense the sample into the injection port 523 and thereby into the analytical instrument 20. Before and/or after this procedure, the probe 324 may be aligned with each of the washing solution container, the rinse fluid container, and the waste container in a desired sequence to clean the probe 324. After the sample is extracted from the target sample container 80T, the sampling head 321 and gripper 830 are used to remove the target sample container 80T from the processing station PS and deposit the target sample container in a seat 351 of a sample carrier 350. Each of these steps is executed under the control of the controller 52. The alignment of the probe 324 with the respective sample containers 80, 80X is executed by driving the carrier assembly 359 to rotate into a selected position and driving the sampling head 321 along the X-axis and the Z-axis as needed.

While the processing station PS is described herein and shown in FIG. 16 as located on or integrated into the hub 340, in other embodiments the processing station PS may be located elsewhere, or the autosampler or sample analyzer system may not include a dedicated processing station PS. The autosampler or sample analyzer system may include more than one processing station PS. In some embodiments, a given processing station PS is used to receive and process sample containers from (i.e., shared amongst) two or more different sample carrier assemblies forming parts of the autosampler. In these cases, the sampling head 321 and gripper 830 may be used to transport the sample vials between the processing station(s) and sample carrier(s) as needed.

Advantageously, the gripper 830 is or includes a passive elastic structure that serves as a passive compliant gripping end effector to selectively grasp, hold, lift, carry, and release sample containers 80. The operation of the passive gripper 830 is possible using only the actuators and degrees of movement otherwise provided to enable the sampling head 321 to execute its other functions. Namely, the degrees of freedom of the fingers 840 that enable gripping and releasing are driven by the X-axis actuator 326X that is used also to position the sampling head 321 and the probe 324 along the X-axis. The gripper 830 is underactuated in that it does not include or use any dedicated actuator that operates specifically, exclusively or directly on the fingers 840 to displace the fingers 840 (to receive and release the sample container 80) or to close (to capture the sample container 80).

Additionally, the gripper 830 may be manufactured and installed cost-effectively. The gripper 830, or a set of such grippers, can be configured and assembled to enable customization of the autosampler. For example, an operator may be provided with grippers 830 of different sizes and may choose and install a gripper 830 of the size or shape that best fits the size or shape of sample containers 80 that are being handled by the autosampler.

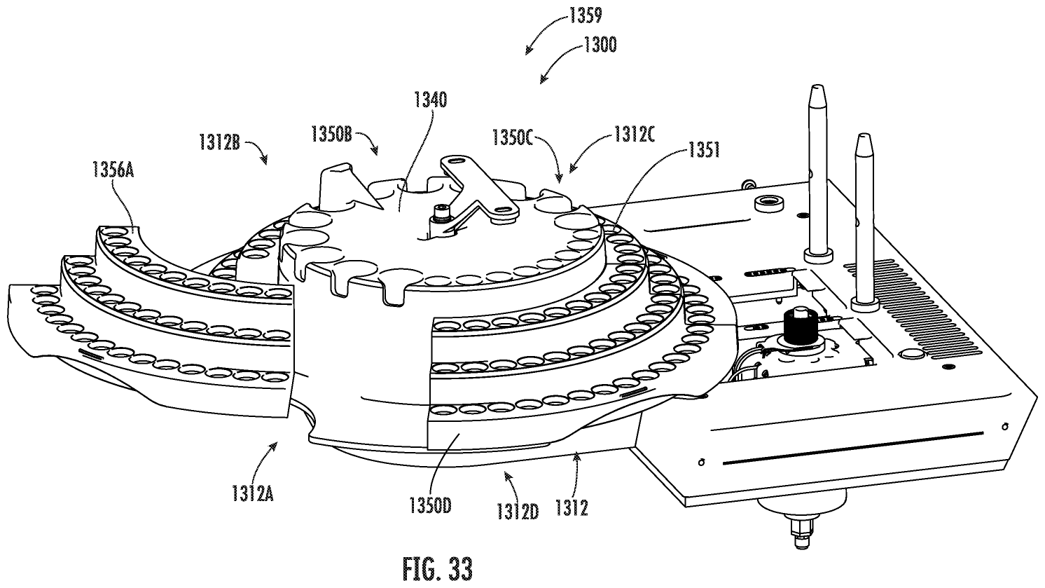

In further embodiments as shown in FIGS. 33-37, an autosampler platform 1312 and carrier assembly 1359 are illustrated. The autosampler platform 1312 and carrier assembly 1359 can be positioned in an autosampler, such as the autosampler 310 of the sample analyzer system 300 as shown in FIG. 16.

The platform 1312 defines one or more sample carrier positions 1312A-1312D. Sample carriers 1350A-1350D are mounted on the platform 1312 in one of the sample carrier positions 1312A-1312D. The hub 1340 is at the center of the platform 1312. The sample carriers 1350A-1350D and the hub 1340 together comprise the carrier assembly 1359. The sample carriers 1350A-1350D include a plurality of carrier seats 1351, which are configured to hold sample containers, such as the sample containers 80 shown in FIG. 16. It should be understood that any suitable number of sample carrier positions and/or sample positions may be used. Thus, the sample carriers 1350A-1350D may have different configurations of sample containers and/or carrier seats 1351. The sample carrier assembly 1359 may be generally constructed as described herein for the sample carrier assemblies 359 and 559, with a tiered configuration as shown with the sample carrier assembly 359. In some embodiments, the hub 1340 is also capable of holding sample containers 80 in a plurality of sample carrier seats 1351.

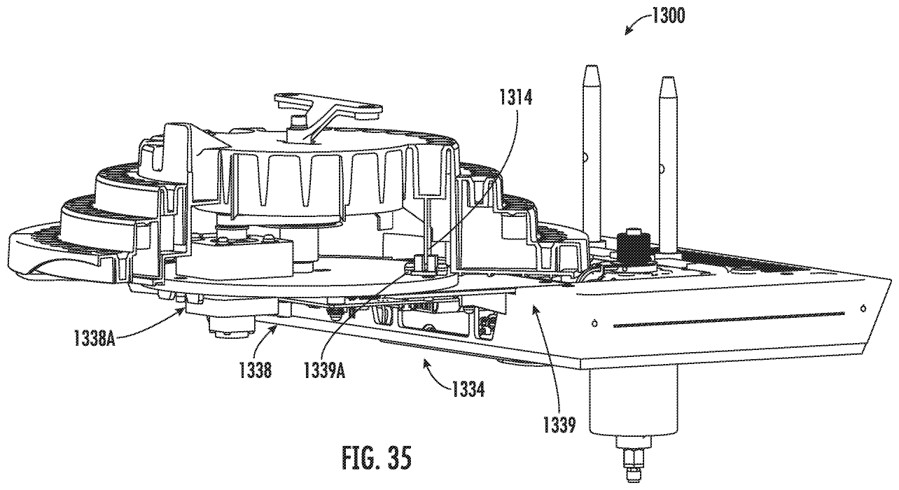

As shown in FIG. 35, a rotational actuator 1334 includes an arm 1339 with a rotating chuck 1338 and drive motor 1338A. The platform 1312 includes an indicia or flag 1314 and the arm 1339 includes a reference sensor 1339A. As illustrated, the reference sensor 1339A is configured to sense or trigger when the flag 1314 is adjacent the sensor 1339A. For example, the reference sensor 1339A may be configured to sense a light signal that is blocked by the flag 1314. In this configuration, the sensor 1339A generates a signal that identifies a reference position of the platform 1312 when it senses the flag 1314. It can be understood that other embodiments may use and/or comprise other sensors and/or sensor configurations for generating and/or otherwise identifying a reference position of the autosampler platform 1312 and that the disclosed systems and methods are not limited to the illustrated example.

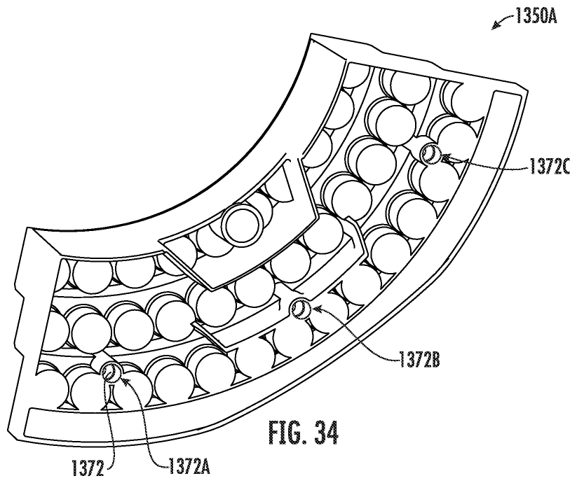

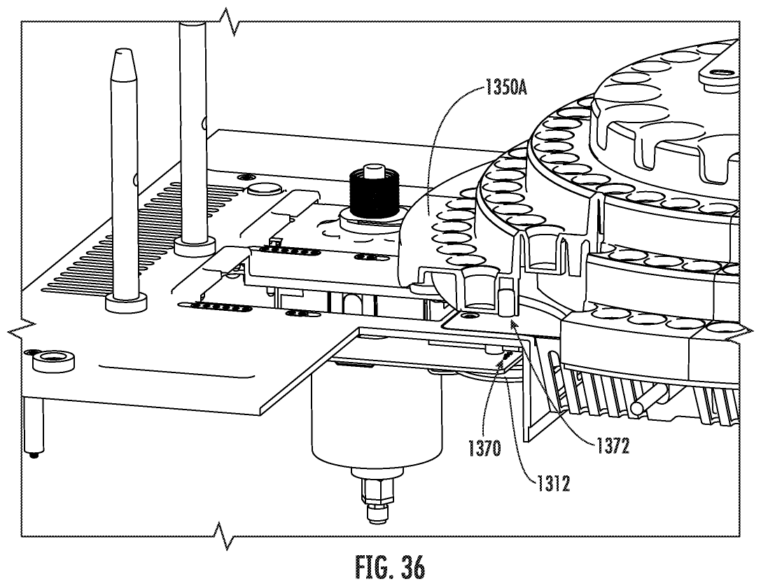

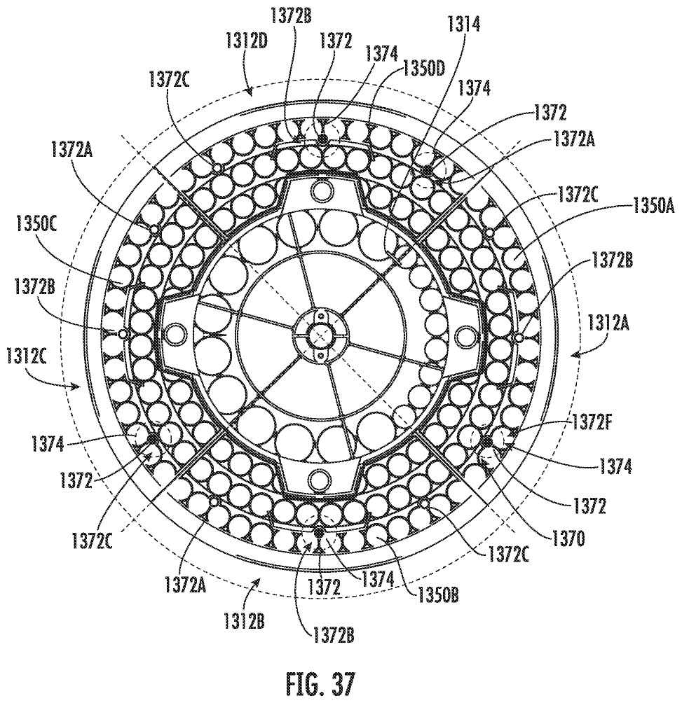

As shown in FIGS. 34, 36 and 37, each of the sample carriers 1350A-1350D comprise at least one magnet 1372. In the illustrated embodiment, the at least one magnet 1372 is mounted on a bottom surface of the sample carrier 1350A (FIG. 34). As shown in FIG. 36, at least one magnetic field detector 1370 is mounted on the autosampler and is configured to detect a magnetic field from the at least one magnet 1372 on the sample carrier 1350A to identify a position 1312A-1312D and/or identity of a sample carrier 1350A mounted on the platform 1312. The sample carriers 1350A-1350D may be removable and interchangeable in the positions 1312A-1312D on the platform 1312. The position of the magnetic field detector 1370 with respect to the sample carriers 1350A-1350D is shown in FIG. 37.

As shown in FIG. 34, the illustrated sample carrier 1350A includes three magnet positions 1372A-1372C (although the present disclosure is not limited to three positions and allows for, e.g., sample carriers with one uniquely identifiable magnet position for each sample carrier, sample carriers with two magnet positions, four magnet positions, five magnet positions, etc., and therefore, the present methods and systems disclose a sample carrier with one or more magnet positions for receiving magnets such that magnets, when located in the one or more magnet positions, allow for uniquely identifying and/or determining the position of a sample carrier when mounted on the platform 1312 by generating a detectable magnetic field pattern relative to the platform reference position/signal), and the magnet 1372 is mounted in the first position 1372A. In the illustrated embodiment where the different sample carriers have the same three magnet positions, it should be understood that any number of one or more of the three magnet positions may be used. Accordingly, the illustrated embodiment, the sample carriers 1350A-1350D may each have different patterns of filled and unfilled magnet positions 1372A-1372C. As shown in FIG. 37, the sample carrier 1350A has a magnet 1372 in the first position 1372A, the sample carrier 1350B has a magnet 1372 in the second position 1372B, the sample carrier 1350C has a magnet 1372 in the third position 1372C, and the fourth sample carrier 1350D has a magnet 1372 in the first and second positions, 1372A and 1372B. Other patterns of filled/unfilled magnet positions may be used, such as configurations in which magnets 1372 are positioned in the first and third positions 1372A and 1372C or the second and third positions 1372B and 1372C. One of ordinary skill will understand that with three magnet positions, as many as 8 different magnetic field options may be allowed (e.g., no magnet in any position, a magnet only in the first position, a magnet only in the second position, a magnet only in the third position, a magnet in the first and second positions, a magnet in the first and third positions, a magnet in the second and third positions, and a magnet in the all three positions). Thus, the filled/unfilled pattern of magnets 1372 in the magnet positions 1372A-1372C shown, e.g., in FIG. 37, each generate one of a plurality of corresponding magnetic field patterns that when detected, may identify a configuration of the sample carrier, such as a position on the platform, and/or a number and arrangement of sample containers, and/or a size of the sample carrier. The magnetic field pattern of the magnets 1372 in the magnet positions 1372A-1372C may be used to identify the number of sample containers, content of sample containers, positions of sample containers and the like for the sample carriers 1350A-1350D, for example, based on a database or lookup table.

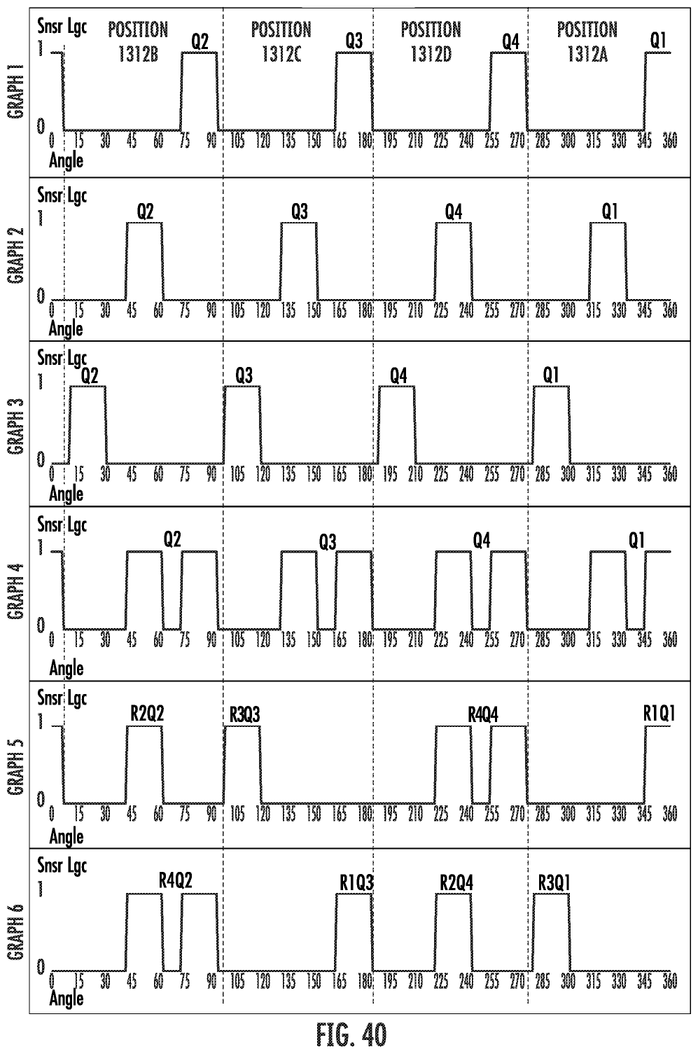

As shown in FIGS. 36 and 37, the magnetic field detector(s) 1370 may be a Hall effect sensor that is configured to detect a presence or absence of a magnet 1372 in the pattern of filled and/or unfilled magnet positions 1372A-1372C. For example, as shown in FIGS. 37 and 40, when a magnet 1372 passes the Hall effect sensor or magnetic field detector 1370, the signal from the magnetic field detector 1370 is elevated or triggered to indicate that a magnetic field 1374 is detected, and a magnet 1372 is in the relative one of the magnet positions 1372A-1372C, i.e., the relative one of the magnet positions 1372A-1372C is filled. As noted above, the reference sensor 1339A is configured to sense or trigger when the (reference) flag 1314 is adjacent the sensor 1339A. The position of the (reference) flag 1314 can be further used to determine a reference position of the platform 1312. For example, as shown in FIG. 37, for the illustrated platform 1312 that includes four positions/quadrants for sample carriers, e.g., first, second, third and fourth quadrant, when the platform (and sample carriers located thereon) 1312 rotates clockwise so that the flag 1314 is detected by the sensor 1339A, the magnetic field detector 1370 begins to detect the magnetic field pattern from the magnets in the sample carrier in the second quadrant or platform position 1312B.

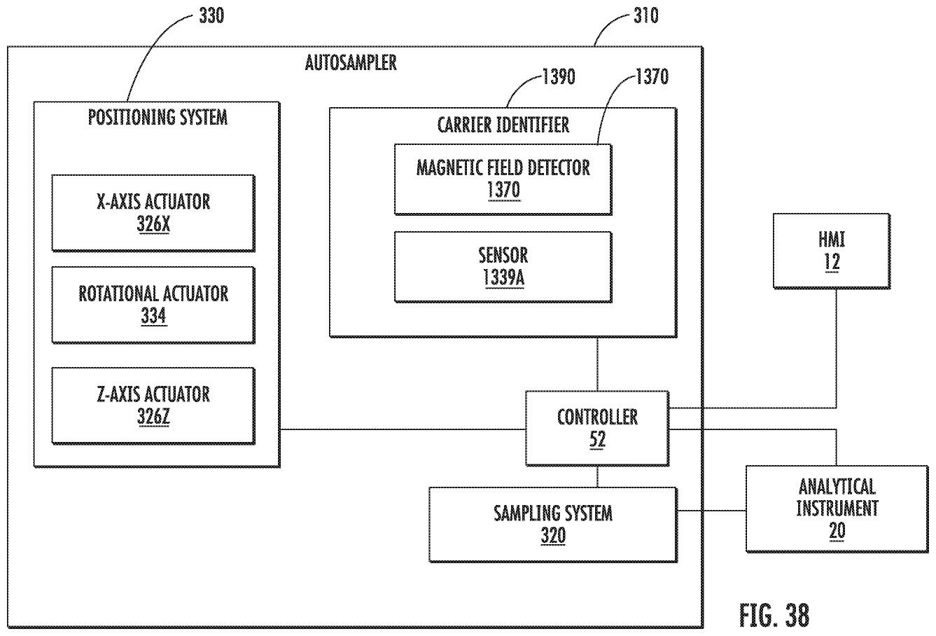

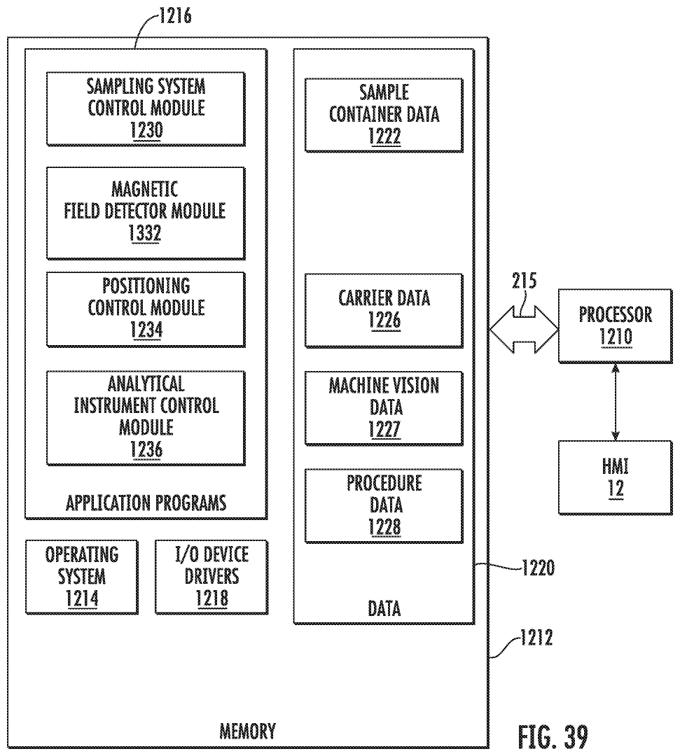

Relative timing of the signals indicating the filled or unfilled status of the magnet positions 1372A-1372C as sensed by the magnetic field detector 1370 with reference to the position of the flag 1314 as sensed by the flag sensor 1339A may be used to control an autosampler as described with respect to FIGS. 38-39. For example, the magnetic field detector 1370 may be triggered to begin detecting the magnetic field when the flag 1314 is sensed by the sensor 1339A. Based on the position of a given sample carrier on the platform 1312, the disclosed methods and systems are able to determine the exact location (seta) of each uniquely coded sample container within a given sample carrier, and in more particularity, the position or seat of each sample container relative to the seats and/or positions for sample containers on the processing station PS, thereby allowing the autosampler/platform to move appropriately to align the controller/gripper (having the removed sample container) with an open sample container seat on the processing station PS based on the position/seat of the remove sample container that is in the gripper.

FIG. 38 is a schematic diagram representing a sample analyzer system analogous to that shown in FIG. 23. The magnetic field detector 1370 and the sensor 1339A are in communication with the sample carrier identifier module 1390. When the platform 1312 rotates so that the magnetic field detector 1370 detects a magnetic field from one of the platform positions 1312A-1312D, the signal from the magnetic field detector 1370 is received by the sample carrier identifier module 1390. The sample carrier identifier module 1390 may determine in which one of the positions 1312A-1312D one of the sample carriers 1350A-1350D has been placed based on the signal from the magnetic field detector 1370 and the reference position detected by the sensor 1339A. The carrier identifier module 1390 may thereafter use information, such as a look up table or database (such as the carrier data 1226 in FIG. 39), to identify information regarding the configuration of the sample carrier 1350A-1350D, including a number and arrangement of the samples (and/or sample containers).

The sample carrier identifier module 1390 may provide information regarding the configuration and/or location of the sample carriers 1350A-1350D to the controller 52 for controlling the sampling system 320, the positioning system 330 and the analytical instrument 20 as further described with respect to FIG. 23.

FIG. 39 is a schematic diagram representing a controller forming a part of the sample analyzer system of FIG. 38 and analogous to that described with respect to FIG. 24. The application programs 1216 can include a magnetic field detection module 1332 that receives signals from the magnetic field detector 1370 and/or the sensor 1339A to identify the position and/or configuration of the sample carriers 1350A-1350D.

Example data for the illustrated magnetic field detector 1370 are shown in FIG. 40. Graphs 1-6 are graphs of signals from the magnetic field detector 1370 that are initiated when the sensor 1339A detects the reference position of the flag 1314. The graphs are divided into four sections, with the first section corresponding to platform position 1312B, the second section corresponding to platform position 1312C, the third section corresponding to platform position 1312D, and the fourth section corresponding to platform position 1312A.

In particular, Graph 1 illustrates a detected magnetic field signal pattern when a sample carrier 1350A is in each of the four example platform positions 1312A-1312D and each sample carrier has a magnet 1372 in the first magnet position 1372A. Graph 2 illustrates a detected magnet field signal pattern when a sample carrier 1350B is in each of the four example platform positions 1312A-1312D and each sample carrier has a magnet 1372 in the second magnet position 1372B. Graph 3 illustrates a detected magnetic field signal pattern when a sample carrier 1350C is in each of the four example platform positions 1312A-1312D and each sample carrier has a magnet 1372 in the third magnet position 1372C. Graph 4 illustrates a detected magnetic field signal pattern when a sample carrier 1350D is in each of the four example platform positions 1312A-1312D and has a magnet 1372 in the first and second magnet position 1372A and 1372B.

Graph 5 illustrates a detected magnetic field signal pattern in which sample carrier 1350A is in platform position 1312A and has a magnet 1372 in the first magnet position 1372A, sample carrier 1350B is in platform position 1312B and has a magnet 1372 in the second magnet position 1372B, sample carrier 1350C is in platform position 1312C and has a magnet 1372 in the third magnet position 1372C, and sample carrier 1350D is in platform position 1312D and has a magnet 1372 in the first and second magnet positions 1372A and 1372B.

Graph 6 illustrates a detected magnetic field signal pattern in which sample carrier 1350C is in platform position 1312A and has a magnet 1372 in the third magnet position 1372C, sample carrier 1350D is in platform position 1312B and has a magnet 1372 in the first and second magnet positions 1372A and 1372B, sample carrier 1350A is in platform position 1312C and has a magnet 1372 in the first magnet position 1372A, and sample carrier 1350B is in platform position 1312D and has a magnet 1372 in the second magnet position 1372B.

Thus, the magnetic field detection module 1332 of FIG. 39 can receive the signal from magnetic field detector 1370 (e.g., a Hall effect sensor) as initiated by the indicia sensor 1339A, and using the information from the flag/reference, output a position and identity of a sample carrier 1350A-1350D that is mounted on the platform 1312.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described herein, what is conceptually equivalent, and also what incorporates the essential idea of the invention.

1. An autosampler comprising:
a sample carrier for receiving a first set of sample containers and a second set of sample containers, each of the sample containers having a top end, a side wall, and a visible indicium on its side wall;
an optical sensor configured to read the visible indicia and to generate an output signal corresponding thereto;
a controller configured to receive the output signal; and
a sampling system to withdraw a sample from at least one of the sample containers;
wherein the sample carrier supports the first and second sets of sample containers at different heights such that the indicia of the sample containers of the second set are located above the top ends of the sample containers of the first set, whereby the indicia of the sample containers of the second set are exposed to the optical sensor over the top ends of the sample containers of the first set, thereby enabling the optical sensor to read the indicia of the second set of sample containers.

2. The autosampler of claim 1 wherein the sample carrier includes tiered first and second support features to receive the first set of sample containers and the second set of sample containers, respectively.

3. The autosampler of claim 2 wherein the first and second support features include seats each configured to hold and positively position an individual sample container in the sample carrier.

4. The autosampler of claim 3 wherein:
the seats of the first support feature are arranged in a first row; and
the seats of the second support feature are arranged in a second row located behind the first row.

5. The autosampler of claim 3 wherein:
the first and second rows are arcuate; and
the autosampler is configured to rotate the sample carrier and/or the optical sensor relative to one another.

6. The autosampler of claim 1 including a vacancy marker on the sample carrier, wherein when the vacancy marker is exposed to the optical sensor, the autosampler determines that no sample container is mounted in a corresponding location in the sample carrier.

7. The autosampler of claim 6 wherein the vacancy marker is disposed on an upstanding wall of the sample carrier located behind the corresponding location in the sample carrier such that:
when no sample container is mounted in a corresponding location in the sample carrier, the vacancy marker is exposed to the optical sensor; and
when a sample container is mounted in the corresponding location, the vacancy marker is obfuscated from the optical sensor by said sample container.

8. The autosampler of claim 1 wherein:
the optical sensor has a field of view; and
the indicium of a sample container of the first set and the indicium of a sample container of the second set located behind said sample container of the first set are simultaneously disposed in the field of view of the optical sensor.

9. The autosampler of claim 8, further comprising at least one mirror configured to simultaneously reflect an image of the indicium of the sample container of the first set and an image of the indicium of the sample container of the second set to the optical sensor.

10. The autosampler of claim 1, further comprising at least one mirror configured to reflect an image of indicia from a sample container of the second set to the optical sensor.

11. The autosampler of claim 10, further comprising at least one folding mirror optically interposed between the optical sensor and the at least one mirror.

12. The autosampler of claim 1 wherein the optical sensor has a central line of sight that is oriented at an oblique angle to a heightwise axis of sample carrier.

13. The autosampler of claim 1 wherein:
the sampling system includes a sampling station; and
the optical sensor is mounted on the sampling station and configured to read the indicium of each sample container when the sample container is positioned adjacent the sampling station.

14. The autosampler of claim 13 wherein:
the sampling station includes a sampling head;
the sampling head includes a probe;
the autosampler includes at least one actuator operable to selectively move the sampling head relative to the sample carrier;
the autosampler includes a passive gripper mounted on the sampling head for movement with the sampling head; and
the passive gripper is configured to releasably grasp and hold the sample containers to remove the sample containers from the sample carrier.

15.-26. (canceled)

27. An autosampler comprising:
a platform that defines one or more sample carrier positions;
at least one sample carrier that is mounted on the platform in one of the sample carrier positions, the at least one sample carrier having at least one magnet thereon and being configured to receive a plurality of sample containers;
a sampling system to enable the withdrawal of a sample from at least one of the sample containers; and
at least one magnetic field detector mounted on the autosampler and configured to detect a magnetic field from the at least one magnet on the sample carrier to thereby identify a position of the at least one sample carrier mounted on the platform.

28. The autosampler of claim 27, wherein the at least one sample carrier comprises a plurality of sample carriers, each of the plurality of sample carriers corresponding to one of a plurality of magnetic field patterns that identify a configuration of the sample carrier.

29. The autosampler of claim 28, wherein each of the plurality of magnetic field patterns comprises a pattern of filled and/or unfilled magnet positions.

30. The autosampler of claim 29, wherein the at least one magnetic field detector mounted on the autosampler comprises a Hall effect sensor that is configured to detect a presence or absence of a magnet in the pattern of filled and/or unfilled magnet positions.

31. The autosampler of claim 30, wherein each of the plurality of magnetic field patterns corresponds to and identifies a configuration of the sample carrier including a number and arrangement of sample containers and/or size of the sample carrier.

32. The autosampler of claim 31, wherein the platform is rotatable, and the autosampler further comprises an indicia mounted on the platform that identifies a reference position of the platform.

33. The autosampler of claim 32, further comprises an indicia detector that is configured to detect a reference position of the indicia when the platform is rotated.

34. The autosampler of claim 33, wherein the Hall effect sensor is configured to generate a signal when the platform is rotated, the signal indicating when a presence or absence of a magnet in the pattern of filled and/or unfilled magnet positions is proximate the Hall effect sensor.

35. The autosampler of claim 34, further comprising a signal analyzer that receives the signal from Hall effect sensor and the indicia detector and outputs a position and identity of the at least one sample carrier that is mounted on the platform in response to the reference position of the platform identified by the position of the indicia and the signal indicating when a presence or absence of a magnet in the pattern of filled and/or unfilled magnet positions is proximate the Hall effect sensor.

36. The autosampler of claim 27, wherein the sampling system further comprises a sample probe to collect a sample from one of the plurality of sample containers and a positioning system configured to move the sample probe.

37. The autosampler of claim 27, wherein the platform is configured to move the one or more sample carriers, and the at least one magnetic field detector is positioned on a stationary component of the autosampler that is stationary with respect to the platform.

38. The autosampler of claim 27, wherein the one or more sample carriers are wedge-shaped.

39. A method for sampling, the method comprising:
Providing an autosampler including a platform, wherein the platform defines one or more sample carrier positions;
mounting at least one sample carrier on the platform in one of the sample carrier positions, the at least one sample carrier being configured to receive a plurality of sample containers and having at least one magnet thereon;
receiving a signal corresponding to a magnetic field on the sample carrier using a magnetic field detector mounted on the autosampler;
determining a configuration and/or position of the sample carrier responsive to the signal from the magnetic field detector; and
withdrawing a sample from at least one of the sample containers with a sample system based on the configuration and/or position of the sample carrier.
